(19) United States
(12) Patent Application Publication
(10) Pub. No.: US 2025/0363261 A1
(43) Pub. Date: Nov. 27, 2025

(54) AUTOMATED INTEGRITY MANAGEMENT OF PIPE NETWORKS AND RELATED STRUCTURES

(71) Applicant: Chevron U.S.A. Inc., San Ramon, CA (US)

(72) Inventors: Kamaldev Raghavan, Houston, TX (US); Antonio C. F. Critsinelis, Kingwood, TX (US); Rui Wang, Katy, TX (US); Jonathan Richard Bowman, Houston, TX (US); Hailing An, Houston, TX (US)

(21) Appl. No.: 19/182,832

(22) Filed: Apr. 18, 2025

Related U.S. Application Data
(60) Provisional application No. 63/651,118, filed on May 23, 2024.

(51) Int. Cl. G06F 30/18; G06F 30/20; G06F 113/14

(52) U.S. Cl. CPC G06F 30/18; G06F 30/20; G06F 2113/14

(57) ABSTRACT

A method for evaluating a pipe network in service may include obtaining design data, manufacturing data, environmental data, fluid data, data associated with installation, maintenance, calibration, and repair, and optional other sensor data for the pipe network. All of this data is evaluated using one or more algorithms. Based on this evaluation, a condition of the pipe network, or pipe network sections thereof, is determined. In some cases, a recommended course of action with respect to the pipe network is presented. In some cases, a dashboard is used to present data and/or receive user input. Example embodiments may self-correct and improve the algorithms used to evaluate the data and determine the condition of the pipe network.

### CROSS-REFERENCE TO RELATED APPLICATIONS

This application claims priority to U.S. Provisional Patent Application Ser. No. 63/651,118 titled “Automated Integrity Management Of Pipe Networks And Related Structures” and filed on May 23, 2024, the entire contents of which are hereby incorporated herein by reference.

### TECHNICAL FIELD

The present application is related to pipe networks and related structures and, more particularly, to systems and methods for automated integrity management of pipe networks and related structures.

### BACKGROUND

Pipe networks may be made of a number of different materials, put in any of a wide array of environments, and used to transport a wide range of fluids. When a pipe network (or sections thereof) fails, the effects, direct and indirect, may be numerous. Some of the effects may include, but are not limited to, loss of time, costs to repair or replace, lost opportunity costs, damage to other equipment, damage to nearby structures, loss or spoilage of production materials, cost to replace lost product, and inconvenience. Acting on knowledge of when a pipe network (or section thereof) is failing, before the point of failure, may help avoid or greatly reduce many of these adverse effects.

### SUMMARY

In general, in one aspect, the disclosure relates to a method for evaluating a pipe network in service. The method includes obtaining design data for the pipe network, where the design data comprises details about a design of the pipe network. The method also includes obtaining manufacturing data for the pipe network, where the manufacturing data comprises a thickness of pipe network sections of the pipe network and a material of the pipe network sections of the pipe network. The method further includes obtaining environmental data associated with the pipe network while the pipe network is in service, where the environmental data comprises a range of temperatures at which the pipe network is exposed, a range of humidity at which the pipe network is exposed, and a medium in which the pipe network is placed. The method also includes obtaining fluid data for fluid flowing through the pipe network while the pipe network is in service, where the fluid data comprises a composition of the fluid. The method further includes obtaining installation and maintenance (I&M) data associated with installing and maintaining the pipe network. The method also includes evaluating the manufacturing data, the environmental data, the fluid data, and the I&M data against the design data using a plurality of algorithms. The method also includes determining, based on evaluating the manufacturing data, the environmental data, the fluid data, and the I&M data against the design data, a condition of the pipe network while the pipe network is in service.

In another aspect, the disclosure relates to a system for evaluating a pipe network in service. The system includes a controller that is configured to obtain design data for the pipe network, where the design data comprises details about a design of the pipe network. The controller is also configured to obtain manufacturing data for the pipe network, where the manufacturing data comprises a thickness of pipe network sections of the pipe network and a material of pipe network sections of the pipe network. The controller is further configured to obtain environmental data associated with the pipe network while the pipe network is in service, where the environmental data comprises a range of temperatures at which the pipe network is exposed, a range of humidity at which the pipe network is exposed, and a medium in which the pipe network is placed. The controller is also configured to obtain fluid data for fluid flowing through the pipe network while the pipe network is in service, where the fluid data comprises a composition of the fluid. The controller is further configured to obtain installation and maintenance (I&M) data associated with installing and maintaining the pipe network. The controller is also configured to evaluate the manufacturing data, the environmental data, the fluid data, and the I&M data against the design data using a plurality of algorithms. The controller is further configured to determine, based on evaluating the manufacturing data, the environmental data, the fluid data, and the I&M data against the design data, a condition of the pipe network while the pipe network is in service.

In yet another aspect, the disclosure relates to a non-transitory computer readable medium comprising computer readable program code, which when executed by a computer processor, enables the computer processor to: obtain design data for a pipe network, where the design data comprises details about a design of the pipe network; obtain manufacturing data for the pipe network, where the manufacturing data comprises a thickness of pipe network sections of the pipe network and a material of pipe network sections of the pipe network; obtain environmental data associated with the pipe network while the pipe network is in service, where the environmental data comprises a range of temperatures at which the pipe network is exposed, a range of humidity at which the pipe network is exposed, and a medium in which the pipe network is placed; obtain fluid data for fluid flowing through the pipe network while the pipe network is in service, where the fluid data comprises a composition of the fluid; obtain installation and maintenance (I&M) data associated with installing and maintaining the pipe network; evaluate the manufacturing data, the environmental data, the fluid data, and the I&M data against the design data using a plurality of algorithms; and determine, based on evaluating the manufacturing data, the environmental data, the fluid data, and the I&M data against the design data, a condition of the pipe network while the pipe network is in service.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a block diagram of a system for automated integrity management of pipe networks and related structures according to certain example embodiments.

FIG. 2 shows a block diagram of the pipe network evaluation system of FIG. 1 according to certain example embodiments.

FIG. 3 shows a diagram of a computing system according to certain example embodiments.

FIG. 4 shows a flowchart of a method for automated integrity management of pipe networks and related structures according to certain example embodiments.

FIG. 5 shows a system that includes two pipe networks that are evaluated according to certain example embodiments.

FIG. 6 shows another system that includes a pipe network that is evaluated according to certain example embodiments.

FIG. 7 shows yet another system that includes a pipe network that is evaluated according to certain example embodiments.

FIGS. 8A and 8B show a functional diagram for evaluating a subsea pipeline according to certain example embodiments.

### DETAILED DESCRIPTION

The example embodiments discussed herein are directed to systems and methods for automated integrity management of pipe networks and related structures. Pipe networks that are evaluated using example embodiments may have any of a number of configurations (e.g., flowlines, risers, jumpers) and/or components (e.g., flexible joint and stress joints elements at top of risers, pipeline end terminations, buckle arrestor, connectors, pipe in pipe, coating and insulation, sensor clamp, buoyancy modules, buckle mitigation such as sleeper, crossing). The environment in which some or all of a pipe network is located may vary. Evaluation of a pipe network, including pipe network sections thereof, using example embodiments is designed to occur in real time while the pipe network is in service. Example embodiments may be used when a pipe network is used in particular ways and/or operations. For example, when a pipe network is used in a subsea field operation (e.g., occurrence of corrosive fluids with CO2 and H2S content, stimulation acid return) where pipeline bore environment is exposed to temporary or permanent acidic fluid, example embodiments may determine in real time the integrity of the entire pipe network and how the acidic fluid impacts the integrity of the pipe network over time.

In some cases, a pipe network that is evaluated using example embodiments is used in field operations (e.g., drilling, completing, transporting, and/or producing a subterranean resource that is extracted from a subterranean formation). A pipe network may be in service for any duration of time (e.g., one month, one year, one decade, over 100 years) and may be continuous or have multiple interruptions or pauses and be subject to varying conditions (fluid, operating regimes, metocean environmental loading, vessel motions). Example embodiments of systems and methods for evaluating pipe networks may be rated for use in in varying conditions during the field life of the pipe network (or pipe network sections thereof).

In some cases, a pipe network (including pipe network sections thereof) that is evaluated using example embodiments may be located, at least in part, under water (e.g., a sea, an ocean, a lake), also called subsea herein, as part of a subterranean field operation. A user as defined herein may be any person associated with a pipe network. Examples of a user may include, but are not limited to, an engineer, a company representative, a consultant, an operator, a technician, an electrician, a pipefitter, a welder, an inspector, a coater, a government agency, a regulatory body, an industry installation and equipment supplier organization.

When used in certain systems (e.g., for certain subterranean (e.g., subsea, land based) field operations, for pipelines, for manufacturing processing), example embodiments may be designed to help such systems comply with certain standards and/or requirements. Examples of entities that set such standards and/or requirements may include, but are not limited to, the Society of Petroleum Engineers, the American Petroleum Institute (API), the International Standards Organization (ISO), the Environmental Protection Agency (EPA), Bureau Safety and Environmental Enforcement (BSEE), Det Norske Veritas (DNV), the National Oceanographic and Atmospheric Administration (NOAA), and the Occupational Safety and Health Administration (OSHA). Also, as discussed above, example systems for automated integrity management of pipe networks and related structures (or portions thereof) may be used in hazardous environments, and so example systems for automated integrity management of pipe networks and related structures (or portions thereof) may be designed to comply with industry standards that apply to hazardous environments.

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. The numbering scheme for the various components in the figures herein is such that each component is a three-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings may be capable of being included in one or more claims that correspond to such one or more particular drawings herein.

Example embodiments of systems for automated integrity management of pipe networks and related structures will be described more fully hereinafter with reference to the accompanying drawings, in which example embodiments of systems for automated integrity management of pipe networks and related structures are shown. Systems for automated integrity management of pipe networks and related structures may, however, be embodied in many different forms and should not be construed as limited to the example embodiments set forth herein. Rather, these example embodiments are provided so that this disclosure will be thorough and complete, and will fully convey the scope of systems for automated integrity management of pipe networks and related structures to those of ordinary skill in the art. Like, but not necessarily the same, elements (also sometimes called components) in the various figures are denoted by like reference numerals for consistency.

Terms such as “first”, “second”, “outer”, “inner”, “top”, “bottom”, “upper”, “lower”, “distal”, “proximal”, “on”, and “within”, when present, are used merely to distinguish one component (or part of a component or state of a component) from another. This list of terms is not exclusive. Such terms are not meant to denote a preference or a particular orientation, and they are not meant to limit embodiments of systems for automated integrity management of pipe networks and related structures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

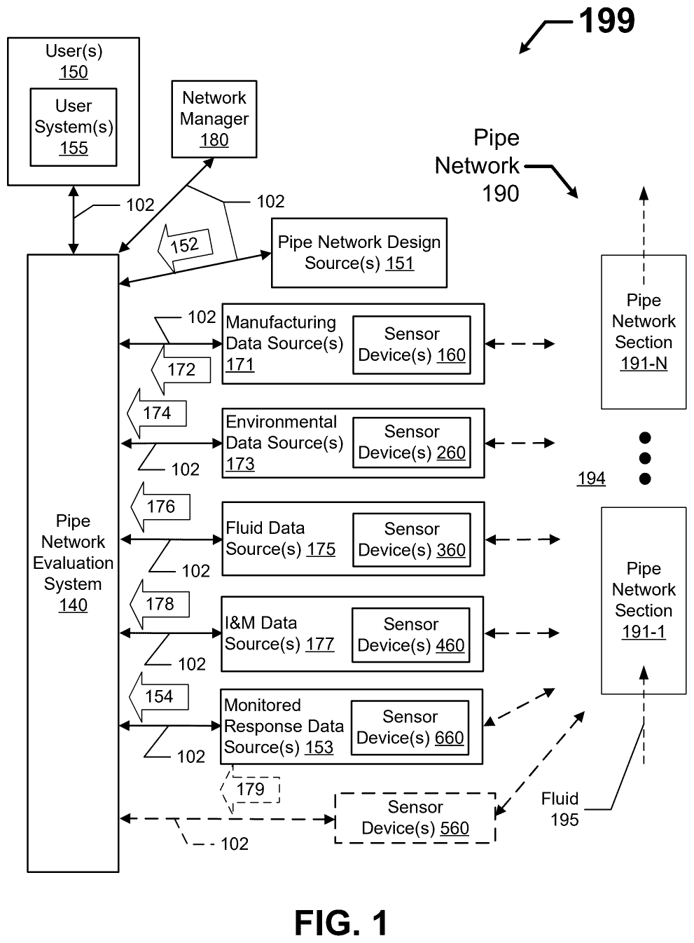

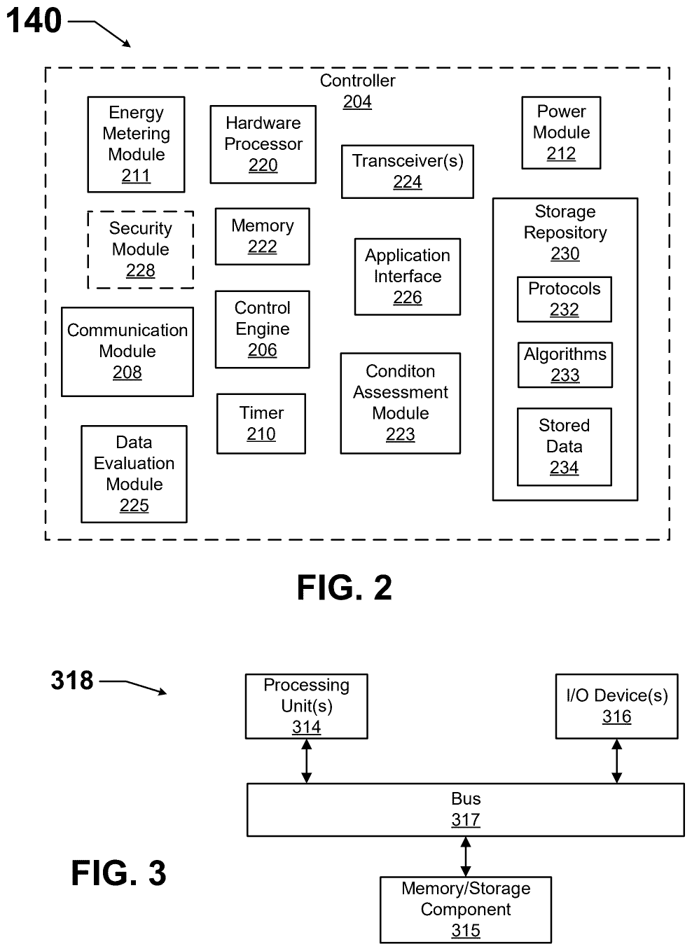

FIG. 1 shows a block diagram of a system 199 for automated integrity management of pipe networks and related structures according to certain example embodiments. FIG. 2 shows a block diagram of the pipe network evaluation system 140 of the system 199 of FIG. 1 according to certain example embodiments. The system 199 of FIG. 1 includes a pipe network 190, one or more users 150, a network manager 180, the pipe network evaluation system 140, one or more pipe network design sources 151, one or more manufacturing data sources 171 (including one or more sensor devices 160), one or more environmental data sources 173 (including one or more sensor devices 260), one or more fluid data sources 175 (including one or more sensor devices 360), one or more installation and maintenance (I&M) data sources 177 (including one or more sensor devices 460), one or more monitored response data sources 153 (including one or more sensor devices 660), and one or more stand-alone sensor devices 560. The components of the system 199 shown in FIG. 1 are not exhaustive. Any component of the example system 199 may be discrete or combined with one or more other components of the system 199.

The pipe network 190 of the system 199 is made up of one or more pipe network sections 191. For example, in this case, the pipe network 190 includes N pipe network sections 191 (pipe network section 191-1 through pipe network section 191-N). Each pipe network section 191 of the pipe network 190 may have any of a number of characteristics. For example, each pipe network section 191 may be of any length, have any number and/or type of pipes and/or other pipe components (e.g., elbows, T-sections, valves, gauges), have any diameter, have any fluid 195 flow therethrough, and be subject to any metocean environment and vessel motions (part of the environmental data 174) in the environment 194 in which the pipe network section 191 is located. A pipe network section 191 may be a single pipe or multiple pipes. A pipe network section 191 may be arbitrarily created (e.g., every 200 feet of a long, linear pipeline) or a distinct section (e.g., a flowline, a riser, a jumper) of the pipe network 190.

When the pipe network 190 includes multiple pipe network sections 191, the characteristics of one pipe network section 191 may be the same as, or different than, the characteristics of one or more of the other pipe network sections 191. In addition, or in the alternative, when the pipe network 190 includes multiple pipe network sections 191, adjacent pipe network sections 191 may be coupled together in any of a number of ways. In some cases, a pipe network section 191 of the pipe network 190 may itself have multiple portions or sections, and so on. In some cases, some or all of a pipe network section 191 may be made of a thermally conductive material. In some cases, some or all of a pipe network section 191 may be covered in an insulating material.

The pipe network 190 is configured to have one or more fluids 195 flowing therethrough on steady state and/or transient regimes (e.g., shutdown and startup of a well) and varying along field life (e.g., early and late life). A fluid 195 is at least partially made up of a liquid (e.g., water) and/or a gas. In some cases, a fluid 195 also includes one or more solids mixed with the liquid and/or gaseous forms of the fluid 195. The fluid 195 may have any of a number of characteristics (e.g., pH value, viscosity, corrosivity). The fluid 195 may be subjected to any of a number of different conditions and associated gradients (e.g., temperature, pressure, flow rate) within the pipe network 190. When the pipe network 190 includes multiple pipe network sections 191, a fluid 195 flowing through one pipe network section 191 may be the same as, or different than, the fluid 195 flowing through one or more other pipe network sections 191.

The pipe network 190 is placed in one or more of a number of environment194, which may change (e.g., in terms of chemical content, in terms of state (e.g., solid, liquid, gas)) over time for a particular pipe network section 191. When the pipe network 190 is placed in multiple environments, one environment 194 may have the same or different characteristics (e.g., climate-controlled, humid, water-rated, corrosive, hazardous, office space, indoor, outdoor) relative to one or more of the other environments. When the pipe network 190 includes multiple pipe network sections 191, one pipe network section 191 of the pipe network 190 may be located in one environment 194 or in multiple environments 194 (e.g., sea water, fresh water, air, soil, a controlled indoor environment, a caustic indoor environment, a humid environment).

When the pipe network 190 includes multiple pipe network sections 191, the one or more environments 194 in which one pipe network section 191 is located may be the same as, or different than, the one or more environments in which one or more of the other pipe network sections 191 is located. When the environment 194 in which the pipe network 190 (or pipe network section 191 thereof) is located is specialized (e.g., an acid, H₂S, CO₂, corrosive), the pipe network 190 (or pipe network section 191 thereof) may be manufactured and assembled in such a way as to comply with applicable standards for that type of environment194.

The pipe network 190 (including one or more pipe network sections 191 thereof) may include multiple pipes, elbows, joints, sleeves, collars, insulators, flexible joints, pipeline end terminations, and similar components that are coupled to each other (e.g., using coupling features such as mating threads, by welding, by other type of connector, by flanges) to establish a network for transporting the fluid 195. Each component of the pipe network 190 (including one or more pipe network sections 191 thereof) may have an appropriate size (e.g., inner diameter, outer diameter) and be made of an appropriate material (e.g., steel, composite, flexible pipe, PVC, copper) to safely and efficiently handle the pressure, temperature, flow rate, and other characteristics of the fluid 195 that flows therethrough and to comply with the applicable design, manufacturing, material selection criteria, and standards for the environment 194 in which the pipe network 190 (including one or more pipe network sections 191 thereof) is located.

The design data 152 (e.g., the basis of design) may be generated based on inputs obtained by a pipe network design source 151 from one or more other sources (e.g. a user 150 (including an associated user system 155), a manufacturing data source 171, an environmental data source 173, a fluid data source 175). Each input may be received directly from these sources or indirectly through the pipe network evaluation system 140 using one or more communication links 102. A pipe network design source 151 may be or include a user 150 (including an associated user system 155). In addition, or in the alternative, a pipe network design source 151 may be or include a model (a form of an algorithm, such as finite element analysis and other related algorithms 233 discussed below). In some cases, the design data 152 may be used by the pipe network evaluation system 140 to generate “look up” tables, which may be used as a basis for comparing with actual data (e.g., operating conditions) associated with the pipe network 190 or another similar pipe network, which may then be used as feedback on the design.

Each pipe network design source 151 of the system 199 is configured to generate design data 152 with respect to some or all of the pipe network 190 (including one or more pipe network sections 191 thereof). In some cases, additionally the design data 152 obtained, directly or indirectly, from a pipe network design source 151 may be any information associated with the design of the pipe network 190 (including one or more pipe network sections 191 thereof). A pipe network design source 151 may be any person or entity that is involved in the design of the pipe network 190.

Examples of a pipe network design source 151 may include, but are not limited to, a user 150 (e.g., an engineer, a project manager, a consulting firm, an architect and engineering firm), which may include an associated user system 155, that designs some or all of the pipe network 190 (including one or more pipe network sections 191 thereof) and a model (a form of an algorithm, such as the algorithms 233 discussed below) used to design some or all of the pipe network 190 (including one or more pipe network sections 191 thereof). There may be more than one pipe network design source 151 for designing the pipe network 190. In such a case, the design data 152 for the pipe network 190 obtained, directly or indirectly, from a monitored response data source 153 may be distinct from, overlap with, or be duplicative of the design data 152 for the pipe network 190 obtained, directly or indirectly, from one or more of the other pipe network design sources 151. In some cases, a pipe network design source 151 may include its own controller (e.g., controller 204), or portions thereof, which would make the pipe network design source 151 similar to a computer device discussed below with respect to FIG. 3.

The design data 152 for the pipe network 190 that is obtained, directly or indirectly, from a pipe network design source 151 may be any data associated with the design of the pipe network 190 (including one or more pipe network sections 191 thereof). Examples of design data 152 may include, but are not limited to, construction drawings, product specifications, plans, alternatives, comparisons, rationales, component requirements (e.g., quantities, sizes, materials), support infrastructure, types of supports, location of supports, part numbers of pipe, treatments of pipe, length of pipes, manufacturer of pipes, welding specifications, welding flaws, a budget (e.g., financial, the expected useful life of various parts of the proposed pipe network 190 based on expected use), torque values, one or more alternatives to parts of the plan in the event that the corresponding parts of the primary design are not attainable, and suggested placement and types of monitoring equipment (e.g., environmental data sources 173, fluid data sources 175, monitored response data sources 153). The design data 152 may be obtained from a pipe network design source 151 by the pipe network evaluation system 140 using one or more communication links 102.

The design data 152 for the pipe network 190 (including one or more pipe network sections 191 thereof) may be obtained by the pipe network evaluation system 140 from a pipe network design source 151 in any of a number of ways. For example, design data 152 may be obtained by the pipe network evaluation system 140 when a pipe network design source 151 responds to a request for design data 152. Such a request may be made, for example, by the pipe network evaluation system 140, the network manager 180, a user 150 (including an associated user system 155), and/or some other entity within the system 199. As another example, design data 152 may be obtained by the pipe network evaluation system 140 when a pipe network design source 151 broadcasts the design data 152 without a specific recipient.

As yet another example, design data 152 may be obtained by the pipe network evaluation system 140 when a pipe network design source 151 sends the design data 152 in communications specifically addressed to the pipe network evaluation system 140. As still another example, design data 152 may be obtained by the pipe network evaluation system 140 when a user 150 (e.g., an engineer, a consultant) physically obtains design data 152 from a pipe network design source 151 and provides (e.g., scans a document, enters data into a template on a web portal) the design data 152 to the pipe network evaluation system 140.

As yet another example, design data 152 may be obtained by the pipe network evaluation system 140 from another component (e.g., the network manager 180, a user 150 (including an associated user system 155)) of the system 199, which obtains the design data 152, directly or indirectly, from one or more pipe network design sources 151 before providing the design data 152 to the pipe network evaluation system 140. In any case, the design data 152 for the pipe network 190 (including one or more pipe network sections 191 thereof) may be obtained from a pipe network design source 151 by the pipe network evaluation system 140 on a continuous basis, periodically (e.g., every 24 hours), as new design data 152 becomes available, randomly, and/or based on some other factor.

In certain example embodiments, a pipe network design source 151 may use data that is obtained from one or more of the other data sources (e.g., manufacturing data sources 171, environmental data sources 173, fluid data sources 175) in the system 199 to generate design data 152. In such cases, a pipe network design source 151 may obtain such data in any of the matters discussed above with respect to the pipe network evaluation system 140 obtaining design data 152 from a pipe network design source 151.

Each manufacturing data source 171 of the system 199 is configured to provide manufacturing data 172 about the pipe network 190 (including one or more pipe network sections 191 thereof). A manufacturing data source 171 may be any person or entity with access to and/or is involved in the creation or maintenance of the manufacturing data 172. Examples of a manufacturing data source 171 may include, but are not limited to, the manufacturer of the pipe network 190 (including one or more pipe network sections 191 thereof), a distributor of the pipe network 190 (including one or more pipe network sections 191 thereof), a prior owner of the pipe network 190 (including one or more pipe network sections 191 thereof), and a selling entity of the pipe network 190 (including one or more pipe network sections 191 thereof). There may be more than one manufacturing data source 171 for the pipe network 190 (including one or more pipe network sections 191 thereof). In such a case, the manufacturing data 172 for the pipe network 190 obtained, directly or indirectly, from one manufacturing data source 171 may be distinct from, overlap with, or be duplicative of the manufacturing data 172 for the pipe network 190 (including one or more pipe network sections 191 thereof) obtained, directly or indirectly, from one or more of the other manufacturing data sources 171. In some cases, a manufacturing data source 171 may also be a user 150.

The manufacturing data 172 for the pipe network 190 (including one or more pipe network sections 191 thereof) obtained, directly or indirectly, from a manufacturing data source 171 may be any data associated with manufacturing the pipe network 190 (including one or more pipe network sections 191 thereof). In some cases, additionally the manufacturing data 172 for the pipe network 190 (including one or more pipe network sections 191 thereof) obtained, directly or indirectly, from a manufacturing data source 171 may be any data associated with some or all of the ancillary equipment (e.g., brackets, hangers, insulation, grounding capability, pumps, compressors, stress joints, flex joints, j-lay collars, buckle arrestors, anchor forgings, wye forgings) used to physically and/or operationally support the pipe network 190 (including one or more pipe network sections 191 thereof).

Examples of the manufacturing data 172 may include, but are not limited to, specifications used for fabrication, pipe material record books, pipe-end material record books, a welding procedure specification, tensile test data, weld records (Hi-Lo), non-destructive examination data, flaw sizes in a weld, the material(s) of the pipe network 190 (including one or more pipe network sections 191 thereof), the specific composition of the material(s) of the pipe network 190 (including one or more pipe network sections 191 thereof), the inner diameter (ID) of one or more components of the pipe network 190 (including one or more pipe network sections 191 thereof), the outer diameter (OD) of one or more components of the pipe network 190 (including one or more pipe network sections 191 thereof), the thickness of one or more components of the pipe network 190 (including one or more pipe network sections 191 thereof), the tolerance of the thickness of one or more components of the pipe network 190 (including one or more pipe network sections 191 thereof), the length of one or more components of the pipe network 190 (including one or more pipe network sections 191 thereof), the curvature of one or more components of the pipe network 190 (including one or more pipe network sections 191 thereof), the coupling features (e.g., mating threads) used to assemble of the pipe network 190 (including one or more pipe network sections 191 thereof), details (e.g., thread size) about the coupling features of the pipe network 190 (including one or more pipe network sections 191 thereof), the temperature rating of one or more components of the pipe network 190 (including one or more pipe network sections 191 thereof), the pressure rating of one or more components of the pipe network 190 (including one or more pipe network sections 191 thereof), and characteristics (e.g., material, thickness) of any coating (e.g., insulating jacket, a spray-on layer) on a surface (e.g., inner surface, outer surface) of one or more components of the pipe network 190 (including one or more pipe network sections 191 thereof). In some cases, at least some of the manufacturing data 172 for the pipe network 190 (including one or more pipe network sections 191 thereof) is listed on a nameplate and/or spec sheet for the pipe network 190 (including one or more pipe network sections 191 thereof).

When an Engineering Criticality Assessment (ECA) is conducted for a pipe network 190 (including one or more pipe network sections 191 thereof) during the design phase of a project, the primary objective is to develop initial weld acceptance criteria and inspection criteria. A design ECA is intended to be conservative, as it typically uses upper bound inputs from actual test data (e.g., material properties) and predicted environmental loads (e.g., from metocean and design data, rather than in-field monitoring data during operation). The design criteria based on an ECA may often be more conservative. Furthermore, the non-destructive examination (NDE) process leads to a “go-no go” decision, and hence when a flaw is within an acceptable size or limit, the associated weld is considered acceptable for use. However, the actual size of the largest flaw seen within the weld may not be known.

During the as-built and in-service phases, ECA can be conducted with as-built pipe/weld geometry, more accurate environmental/operational loading (e.g., monitoring data), more accurate fluid service conditions, and use of available fabrication/welding NDE data (e.g., actual flaw size detected). This as-built/in-service ECA may be used to potentially reduce conservatism from a design ECA, improve integrity, act as a building block for life extension, and enhance the ability to handle future un-planned events.

The manufacturing data 172 for the pipe network 190 (including one or more pipe network sections 191 thereof) may be obtained, directly or indirectly, from a manufacturing data source 171 by the pipe network evaluation system 140 using one or more communication links 102. As used herein, the term “obtaining” (including variations such as “obtained”) may include collecting, receiving, retrieving, accessing, generating, etc. or any other manner of obtaining information (in this case, manufacturing data 172). Each communication link 102 may include wired (e.g., Class 1 electrical cables, Class 2 electrical cables, electrical connectors, power line carrier, DALI, RS485, UART, SPI, I2C) and/or wireless (e.g., Wi-Fi, visible light communication, cellular networking, visible light communication (VLC), ultrawide band (UWB), 802.15.4 wireless, ZigBee, 4G cellular wireless, Bluetooth, WirelessHART, ISA100) technology.

The manufacturing data 172 for the pipe network 190 (including one or more pipe network sections 191 thereof) may be obtained by the pipe network evaluation system 140 from a manufacturing data source 171 in any of a number of ways. For example, manufacturing data 172 may be obtained by the pipe network evaluation system 140 when a manufacturing data source 171 responds to a request for the manufacturing data 172. Such a request may be made, for example, by the pipe network evaluation system 140, the network manager 180, a user 150 (including an associated user system 155), and/or some other entity within the system 199. As another example, manufacturing data 172 may be obtained by the pipe network evaluation system 140 when a manufacturing data source 171 broadcasts the manufacturing data 172 without a specific recipient.

As yet another example, manufacturing data 172 may be obtained by the pipe network evaluation system 140 when a manufacturing data source 171 sends the manufacturing data 172 in communications specifically addressed to the pipe network evaluation system 140. As still another example, manufacturing data 172 may be obtained by the pipe network evaluation system 140 when a user 150 (e.g., the manufacturer, a consultant) physically obtains the manufacturing data 172 from a manufacturing data source 171 and provides (e.g., scans a document, enters data into a template on a web portal) the manufacturing data 172 to the pipe network evaluation system 140.

As yet another example, manufacturing data 172 may be obtained by the pipe network evaluation system 140 from another component (e.g., the network manager 180, a user 150 (including an associated user system 155)) of the system 199, which obtains the manufacturing data 172, directly or indirectly, from one or more manufacturing data sources 171 before providing the manufacturing data 172 to the pipe network evaluation system 140. In any case, the manufacturing data 172 for the pipe network 190 (including one or more pipe network sections 191 thereof) may be obtained from a manufacturing data source 171 by the pipe network evaluation system 140 on a continuous basis, periodically (e.g., every 24 hours), as new manufacturing data 172 becomes available for components of the pipe network 190, randomly, and/or based on some other factor.

Each manufacturing data source 171 may include one or more sensor devices 160. Each sensor device 160 of a manufacturing data source 171 includes one or more sensors that are configured to measure one or more parameters (e.g., thickness, length, hardness, inner diameter, outer diameter, material(s), chemical components and relative ratio of the material(s), thread type of mating threads) associated with manufacturing one or more components of the pipe network 190. Examples of a sensor of a sensor device 160 may be or include, but are not limited to, a temperature sensor, torque sensor, a laser, a spring gauge, a flow sensor, a pressure sensor, a gas spectrometer, a voltmeter, an ammeter, and a camera. A sensor device 160 may be integrated with equipment used to manufacture the pipe network 190 (including one or more pipe network sections 191 thereof). In other cases, a sensor device 160 may be a standalone component. In some cases, a sensor device 160 may include its own controller (e.g., controller 204), or portions thereof, which would make the sensor device 160 similar to a computer device discussed below with respect to FIG. 3.

Each environmental data source 173 of the system 199 is configured to provide environmental data 174 about the environment 194 in which the pipe network 190 (including one or more pipe network sections 191 thereof) are located. In some cases, additionally the environmental data 174 for the pipe network 190 (including one or more pipe network sections 191 thereof) obtained, directly or indirectly, from an environmental data source 173 may be any data associated with the environment 194 in which some or all of the ancillary equipment (brackets, hangers, insulation, grounding capability, pumps, compressors) used to physically and/or operationally support the pipe network 190 (including one or more pipe network sections 191 thereof) is located.

An environmental data source 173 may be any person or entity with access to and/or is involved in the creation or maintenance of the environmental data 174. Examples of an environmental data source 173 may include, but are not limited to, an environmental consulting firm that monitors the air, soil, and/or water in which the pipe network 190 is located, a monitoring system that is located on site with the pipe network 190, a weather service, a maritime service, and a government agency (e.g., NOAA, EPA, OSHA). There may be more than one environmental data source 173 for the pipe network 190. In such a case, the environmental data 174 for the pipe network 190 obtained, directly or indirectly, from an environmental data source 173 may be distinct from, overlap with, or be duplicative of the environmental data 174 for the pipe network 190 obtained, directly or indirectly, from one or more of the other environmental data sources 173. In some cases, an environmental data source 173 may also be a user 150.

The environmental data 174 for the pipe network 190 that is obtained, directly or indirectly, from an environmental data source 173 may be any data associated with the environment 194 for one or more locations in which the pipe network 190 (including one or more pipe network sections 191 thereof) is placed and/or to which the pipe network 190 (including one or more pipe network sections 191 thereof) is exposed. Examples of the environmental data 174 may include, but are not limited to, air content, moisture content, water content, soil content, humidity (e.g., individual humidity values, a range of humidity values) data, the medium data associated with the medium (e.g., sea water, fresh water, soil, ambient air) in which the pipe network 190 (including one or more pipe network sections 191 thereof) is placed, temperature (e.g., individual temperatures, a range of temperatures) data, wind data, current data (e.g., for water flow), stress/strain data on a structure (e.g., a vessel), vibration data, seismic activity, and pressure data (e.g., atmospheric pressure). The environmental data 174 may include impacts on the pipe network 190 (including one or more pipe network sections 191 thereof and/or including associated ancillary equipment). The environmental data 174 associated with the environment 194 in which the pipe network 190 (including one or more pipe network sections 191 thereof) is placed may be obtained from an environmental data source 173 by the pipe network evaluation system 140 using one or more communication links 102.

The environmental data 174 for the pipe network 190 (including one or more pipe network sections 191 thereof) may be obtained by the pipe network evaluation system 140 from an environmental data source 173 in any of a number of ways. For example, environmental data 174 may be obtained by the pipe network evaluation system 140 when an environmental data source 173 responds to a request for the environmental data 174. Such a request may be made, for example, by the pipe network evaluation system 140, the network manager 180, a user 150 (including an associated user system 155), and/or some other entity within the system 199. As another example, environmental data 174 may be obtained by the pipe network evaluation system 140 when an environmental data source 173 broadcasts the environmental data 174 without a specific recipient.

As yet another example, environmental data 174 may be obtained by the pipe network evaluation system 140 when an environmental data source 173 sends the environmental data 174 in communications specifically addressed to the pipe network evaluation system 140. As still another example, environmental data 174 may be obtained by the pipe network evaluation system 140 when a user 150 (e.g., a government agency, an environmental consultant) physically obtains the environmental data 174 from an environmental data source 173 and provides (e.g., scans a document, enters data into a template on a web portal) the environmental data 174 to the pipe network evaluation system 140.

As yet another example, environmental data 174 may be obtained by the pipe network evaluation system 140 from another component (e.g., the network manager 180, a user 150 (including an associated user system 155)) of the system 199, which obtains the environmental data 174, directly or indirectly, from one or more environmental data sources 173 before providing the environmental data 174 to the pipe network evaluation system 140. In any case, the environmental data 174 for the pipe network 190 (including one or more pipe network sections 191 thereof) may be obtained from an environmental data source 173 by the pipe network evaluation system 140 on a continuous basis, periodically (e.g., every 24 hours), as new environmental data 174 becomes available, randomly, and/or based on some other factor.

Each environmental data source 173 may include one or more sensor devices 260. Each sensor device 260 of an environmental data source 173 includes one or more sensors that are configured to measure one or more parameters (e.g., temperature, humidity, salinity, wind speed, wind direction, current speed, current direction, rainfall total, soil content, air content, acid levels, atmospheric pressure, wave height, wave direction, tidal height) associated with the environment 194 in which the pipe network 190 is placed. Examples of a sensor of a sensor device 260 may be or include, but are not limited to, a temperature sensor, a humidity sensor, a laser, a spring gauge, a flow sensor, a pressure sensor, a gas spectrometer, a voltmeter, an ammeter, and a camera. A sensor device 260 may be integrated with or attached to the pipe network 190 (including one or more pipe network sections 191 thereof). In other cases, a sensor device 260 may be a standalone component. In some cases, a sensor device 260 may include its own controller (e.g., controller 204), or portions thereof, which would make the sensor device 260 similar to a computer device discussed below with respect to FIG. 3.

Each fluid data source 175 of the system 199 is configured to provide fluid data 176 for one or more of the fluids 195 flowing through the pipe network 190 (including one or more pipe network sections 191 thereof). In some cases, additionally the fluid data 176 for the pipe network 190 (including one or more pipe network sections 191 thereof) obtained, directly or indirectly, from a fluid data source 175 may be any data associated with some or all of the ancillary equipment (brackets, hangers, insulation, grounding capability, pumps, compressors, vessels) used to physically and/or operationally move the fluid 195 through the pipe network 190 (including one or more pipe network sections 191 thereof).

A fluid data source 175 may be any person or entity with access to and/or is involved in the creation, monitoring, and/or maintenance of the fluid data 176. Examples of a fluid data source 175 may include, but are not limited to, a manufacturer of the fluid 195, a processor of the fluid 195, a recipient of the fluid 195, a consulting firm that monitors the fluid 195, a management company that manages the fluid 195, and a government agency (e.g., EPA, OSHA). There may be more than one fluid data source 175 for the fluid 195 flowing through the pipe network 190 (including one or more pipe network sections 191 thereof). In such a case, the fluid data 176 for the fluid 195 flowing through the pipe network 190 (including one or more pipe network sections 191 thereof) obtained, directly or indirectly, from a fluid data source 175 may be distinct from, overlap with, or be duplicative of the fluid data 176 for the fluid 195 flowing through the pipe network 190 (including one or more pipe network sections 191 thereof) obtained, directly or indirectly, from one or more of the other fluid data sources 175. In some cases, a fluid data source 175 may also be a user 150.

The fluid data 176 for the pipe network 190 (including one or more pipe network sections 191 thereof) may be any data associated with the fluid 195 flowing through the pipe network 190 (including one or more pipe network sections 191 thereof). Put another way, the fluid data 176 may be associated with the operating data for the pipe network 190 (including pipe network sections 191 thereof). Examples of fluid data 176 may include, but are not limited to, a composition (e.g., by element, by compound, by percentage, by mass) of the fluid 195, temperature of the fluid 195, a flow rate of the fluid 195, a state (e.g., solid, liquid, gas) of the fluid 195, and a pressure of the fluid 195 within the pipe network 190 (including one or more pipe network sections 191 thereof). The fluid data 176 for the pipe network 190 (including one or more pipe network sections 191 thereof) may be obtained from a fluid data source 175 by the pipe network evaluation system 140 using one or more communication links 102.

The fluid data 176 for fluid 195 flowing through the pipe network 190 (including one or more pipe network sections 191 thereof) may be obtained by the pipe network evaluation system 140 from a fluid data source 175 in one or more of a number of ways. For example, fluid data 176 may be obtained by the pipe network evaluation system 140 when a fluid data source 175 responds to a request for the fluid data 176. Such a request may be made, for example, by the pipe network evaluation system 140, the network manager 180, a user 150 (including an associated user system 155), and/or some other entity within the system 199. As another example, fluid data 176 may be obtained by the pipe network evaluation system 140 when a fluid data source 175 broadcasts the fluid data 176 without a specific recipient.

As yet another example, fluid data 176 may be obtained by the pipe network evaluation system 140 when a fluid data source 175 sends the fluid data 176 in communications specifically addressed to the pipe network evaluation system 140. As still another example, fluid data 176 may be obtained by the pipe network evaluation system 140 when a user 150 (e.g., a government agency, an environmental consultant) physically obtains the fluid data 176 from a fluid data source 175 and provides (e.g., scans a document, enters data into a template on a web portal) the fluid data 176 to the pipe network evaluation system 140.

As yet another example, fluid data 176 may be obtained by the pipe network evaluation system 140 from another component (e.g., the network manager 180, a user 150 (including an associated user system 155)) of the system 199, which obtains the fluid data 176, directly or indirectly, from one or more fluid data sources 175 before providing the fluid data 176 to the pipe network evaluation system 140. In any case, the fluid data 176 for the pipe network 190 (including one or more pipe network sections 191 thereof) may be obtained from a fluid data source 175 by the pipe network evaluation system 140 on a continuous basis, periodically (e.g., every 24 hours), as new fluid data 176 becomes available, randomly, and/or based on some other factor.

Each fluid data source 175 may include one or more sensor devices 360. Each sensor device 360 of a fluid data source 175 includes one or more sensors that are configured to measure one or more parameters (e.g., temperature, flow rate, salinity, chemical composition, acidity, turbulence, baseness, fluid state, solid content, scale) associated with the fluid 176 flowing through or otherwise disposed in the pipe network 190. Examples of a sensor of a sensor device 360 may be or include, but are not limited to, an anemometer, an accelerometer (e.g., a linear accelerometer), a gyroscope (e.g., a fiber optic gyroscope), a global positioning system (GPS), an air gap sensor, a motion sensor, a load cell, a strain gauge, a temperature sensor, a humidity sensor, a gas chromatograph, a laser, a flow sensor, a pressure sensor, a gas spectrometer, a voltmeter, an ammeter, and a camera. A sensor device 360 may be integrated with or attached to the pipe network 190 (including one or more pipe network sections 191 thereof). In other cases, a sensor device 360 may be a standalone component. In some cases, a sensor device 360 may include its own controller (e.g., controller 204), or portions thereof, which would make the sensor device 360 similar to a computer device discussed below with respect to FIG. 3.

Each I&M data source 177 of the system 199 is configured to provide I&M data 178 about the pipe network 190 (including one or more pipe network sections 191 thereof). In some cases, additionally the I&M data 178 for the pipe network 190 (including one or more pipe network sections 191 thereof) obtained, directly or indirectly, from an I&M data source 177 may be any data associated with installation, repair, calibration, maintenance, and/or other manipulation of some or all of the ancillary equipment (brackets, hangers, insulation, grounding capability, pumps, compressors) used to physically and/or operationally support the pipe network 190 (including one or more pipe network sections 191 thereof).

An I&M data source 177 may be any person or entity with access to and/or is involved in the installation, repair, calibration, maintenance, and/or other manipulation of the pipe network 190 (including one or more pipe network sections 191 thereof). Examples of an I&M data source 177 may include, but are not limited to, a welder (e.g., a certified welder) or welding company, a maintenance company, a contractor (e.g., an installation contractor), a sub supplier, a pipefitter, an engineering company, a consultant, and a government agency (e.g., EPA, OSHA). There may be more than one I&M data source 177 for the pipe network 190 (including one or more pipe network sections 191 thereof). In such a case, the I&M data 178 for the pipe network 190 (including one or more pipe network sections 191 thereof) obtained, directly or indirectly, from one I&M data source 177 may be distinct from, overlap with, or be duplicative of the I&M data 178 for the pipe network 190 (including one or more pipe network sections 191 thereof) obtained, directly or indirectly, from one or more of the other I&M data sources 177. In some cases, an I&M data source 177 may also be a user 150.

As defined herein, I&M data 178 is any data associated with the installation, maintenance, calibration, repair, and/or other manipulation of the pipe network 190 (including one or more pipe network sections 191 thereof). Accordingly, the I&M data 178 for the pipe network 190 obtained, directly or indirectly, from an I&M data source 177 may be any data associated with changes made to the pipe network 190 (including one or more pipe network sections 191 thereof) during installation, maintenance, calibration, repairs, and/or other events that occur with respect to the pipe network 190 (including one or more pipe network sections 191 thereof). Examples of the I&M data 178 may include, but are not limited to, weather windows and durations encountered during installation, weld/joint numbers, installation survey and assignment sheets, stalk sheets, any as-reeled updates to planned reeling cycles, on-site welding information (e.g., type of weld, location of weld, length/width of weld, welding material used), coatings applied to a surface of the pipe network 190, and treatment (e.g., heat treatment, ionization) applied to the pipe network 190. The I&M data 178 for the pipe network 190 (including one or more pipe network sections 191 thereof) may be obtained by the pipe network evaluation system 140 from an I&M data source 177 using one or more communication links 102.

The I&M data 178 for the pipe network 190 (including one or more pipe network sections 191 thereof) may be obtained by the pipe network evaluation system 140 from an I&M data source 177 in one or more of a number of ways. For example, I&M data 178 may be obtained by the pipe network evaluation system 140 when an I&M data source 177 responds to a request for the I&M data 178. Such a request may be made, for example, by the pipe network evaluation system 140, the network manager 180, a user 150 (including an associated user system 155), and/or some other entity within the system 199. As another example, I&M data 178 may be obtained by the pipe network evaluation system 140 when an I&M data source 177 broadcasts the I&M data 178 without a specific recipient.

As yet another example, I&M data 178 may be obtained by the pipe network evaluation system 140 when an I&M data source 177 sends the I&M data 178 in communications specifically addressed to the pipe network evaluation system 140. As still another example, I&M data 178 may be obtained by the pipe network evaluation system 140 when a user 150 (e.g., a government agency, an environmental consultant) physically obtains the I&M data 178 from an I&M data source 177 and provides (e.g., scans a document, enters data into a template on a web portal) the I&M data 178 to the pipe network evaluation system 140.

As yet another example, I&M data 178 may be obtained by the pipe network evaluation system 140 from another component (e.g., the network manager 180, a user 150 (including an associated user system 155)) of the system 199, which obtains the I&M data 178, directly or indirectly, from one or more I&M data sources 177 before providing the I&M data 178 to the pipe network evaluation system 140. In any case, the I&M data 177 for the pipe network 190 (including one or more pipe network sections 191 thereof) may be obtained from an I&M data source 177 by the pipe network evaluation system 140 on a continuous basis, periodically (e.g., every 24 hours), as new fluid data 176 becomes available, randomly, and/or based on some other factor.

Each I&M data source 177 may include one or more sensor devices 460. Each sensor device 460 of an I&M data source 177 includes one or more sensors that are configured to measure one or more parameters (e.g., thickness, length, hardness, inner diameter, outer diameter, material(s), chemical components and relative ratio of the material(s))) associated with the installation, repair, maintenance, and/or other activity associated the interaction of a user 150 (e.g., maintenance personnel, a consultant) with the pipe network 190 in the field. Examples of a sensor of a sensor device 460 may be or include, but are not limited to, a temperature sensor, a gas chromatograph, a laser, a pressure sensor, a gas spectrometer, a voltmeter, an ammeter, and a camera. A sensor device 460 may be integrated with or part of the equipment used to install, maintain, repair, and/or otherwise manipulate the pipe network 190 (including one or more pipe network sections 191 thereof). In other cases, a sensor device 460 may be a standalone component. In some cases, a sensor device 460 may include its own controller (e.g., controller 204), or portions thereof, which would make the sensor device 460 similar to a computer device discussed below with respect to FIG. 3.

Each monitored response data source 153 of the system 199 is configured to provide monitored response data 154 about the pipe network 190 (including one or more pipe network sections 191 thereof). In some cases, additionally the monitored response data 154 for the pipe network 190 (including one or more pipe network sections 191 thereof) obtained, directly or indirectly, from a monitored response data source 153 may be any data associated with the physical components (e.g., pipes, supports, sleeves) that make up the pipe network 190 (including one or more pipe network sections 191 thereof) is located. A monitored response data source 153 may be any person or entity with access to and/or is involved in the creation or maintenance of the monitored response data 154.

Examples of a monitored response data source 153 may include, but are not limited to, an engineer or an engineering consulting firm that monitors (e.g., continually, periodically) the physical components of the pipe network 190 (including one or more pipe network sections 191 thereof), a monitoring system that measures one or more parameters (e.g., vibration, thickness, corrosion) associated with the pipe network 190 (including one or more pipe network sections 191 thereof), and a government agency (e.g., NOAA, EPA, OSHA). There may be more than one monitored response data source 153 for the pipe network 190. In such a case, the monitored response data 154 for the pipe network 190 obtained, directly or indirectly, from a monitored response data source 153 may be distinct from, overlap with, or be duplicative of the monitored response data 154 for the pipe network 190 obtained, directly or indirectly, from one or more of the other monitored response data sources 153. In some cases, a monitored response data source 153 may also be a user 150.

The monitored response data 154 for the pipe network 190 that is obtained, directly or indirectly, from a monitored response data source 153 may be any data associated with one or more of the physical components of the pipe network 190 (including one or more pipe network sections 191 thereof). Examples of monitored response data 154 may include, but are not limited to, outputs of one or more of the sensor devices 660 (e.g., fracture toughness in non-reeled and (if applicable) reeled conditions in all applicable fluid environments (e.g., in-air, sour, acid), da/dN (Paris curve) test data in all applicable fluid environments (e.g., in-air, sour, or acid), measured residual stress data, in-field pressure monitoring data, in-field temperature monitoring data, in-field pipeline movement/strain data, in-field vessel motion monitoring data), physical measurements (e.g., a distance using a tape measure, using a laser), and human observations (e.g., missing bolt, a broken bracket) with respect to the pipe network 190 (including one or more pipe network sections 191 thereof). The monitored response data 154 may be obtained from a monitored response data source 153 by the pipe network evaluation system 140 using one or more communication links 102.

The monitored response data 154 for the pipe network 190 (including one or more pipe network sections 191 thereof) may be obtained by the pipe network evaluation system 140 from a monitored response data source 153 in any of a number of ways. For example, monitored response data 154 may be obtained by the pipe network evaluation system 140 when a monitored response data source 153 responds to a request for the monitored response data 154. Such a request may be made, for example, by the pipe network evaluation system 140, the network manager 180, a user 150 (including an associated user system 155), and/or some other entity within the system 199. As another example, monitored response data 154 may be obtained by the pipe network evaluation system 140 when a monitored response data source 153 broadcasts the monitored response data 154 without a specific recipient.

As yet another example, monitored response data 154 may be obtained by the pipe network evaluation system 140 when a monitored response data source 153 sends the monitored response data 154 in communications specifically addressed to the pipe network evaluation system 140. As still another example, monitored response data 154 may be obtained by the pipe network evaluation system 140 when a user 150 (e.g., a government agency, an environmental consultant) physically obtains the monitored response data 154 from a monitored response data source 153 and provides (e.g., scans a document, enters data into a template on a web portal) the monitored response data 154 to the pipe network evaluation system 140.

As yet another example, monitored response data 154 may be obtained by the pipe network evaluation system 140 from another component (e.g., the network manager 180, a user 150 (including an associated user system 155)) of the system 199, which obtains the monitored response data 154, directly or indirectly, from one or more monitored response data sources 153 before providing the monitored response data 154 to the pipe network evaluation system 140. In any case, the monitored response data 154 for the pipe network 190 (including one or more pipe network sections 191 thereof) may be obtained from a monitored response data source 153 by the pipe network evaluation system 140 on a continuous basis, periodically (e.g., every 24 hours), as new monitored response data 154 becomes available, randomly, and/or based on some other factor.

Each monitored response data source 153 may include one or more sensor devices 660. Each sensor device 660 of a monitored response data source 153 includes one or more sensors that are configured to measure one or more parameters (e.g., thickness, corrosion, vibration, electrical current, magnetic fields) associated with one or more physical components of the pipe network 190. Examples of a sensor of a sensor device 660 may be or include, but are not limited to, a temperature sensor, a laser, a voltmeter, an ammeter, and a camera. A sensor device 660 may be or include automated ultrasonic testing. One or more sensor devices 660 may be attached to or integrated with a UAV for a pipeline network 190 (or portions thereof) located subsea. A sensor device 660 may be integrated with or attached to the pipe network 190 (including one or more pipe network sections 191 thereof). In other cases, a sensor device 660 may be a standalone component. In some cases, a sensor device 660 may include its own controller (e.g., controller 204), or portions thereof, which would make the sensor device 660 similar to a computer device discussed below with respect to FIG. 3.

In certain example embodiments, one or more sensor devices 560 that are independent of the pipe network design sources 151, the monitored response data sources 153 (including the associated sensor devices 660), the manufacturing data sources 171 (including the associated sensor devices 160), the environmental data sources 173 (including the associated sensor devices 260), the fluid data sources 175 (including the associated sensor devices 360), and the I&M data sources 177 (including the associated sensor devices 460) may be used to collect sensor data 179 associated with the pipe network 190 (including one or more pipe network sections 191 thereof). Specifically, a sensor device 560 of the system 199 may be configured to measure one or more parameters associated with the pipe network 190 (including one or more pipe network sections 191 thereof) that are not already part of the design data 152 and not already measured by the sensor devices 660 of the monitored response data sources 153, by the sensor devices 160 of the manufacturing data sources 171, by the sensor devices 260 of the environmental data sources 173, by the sensor devices 360 of the fluid data sources 175, and by the sensor devices 460 of the I&M data sources 177.

Each sensor device 560 includes one or more sensors that are configured to measure one or more parameters (e.g., temperature, vibration, thickness, length, hardness) associated with the pipe network 190 (including one or more pipe network sections 191 thereof). A parameter measured by a sensor device 560 may duplicate, complement, or be unique relative to the design data 152 obtained, directly or indirectly, from the pipe network design sources 151, monitored response data 154 obtained, directly or indirectly, from the monitored response data sources 153, manufacturing data 172 obtained, directly or indirectly, from the manufacturing data sources 171, the environmental data 174 obtained, directly or indirectly, from the environmental data sources 173, the fluid data 176 obtained, directly or indirectly, from the fluid data sources 175, and the I&M data 178 obtained, directly or indirectly, from the IM data sources 177.

Examples of a sensor of a sensor device 560 may be or include, but are not limited to, a temperature sensor, a gas chromatograph, a laser, a vibration sensor, a pressure sensor, a gas spectrometer, a voltmeter, an ammeter, and a camera. A sensor device 560 may be integrated with or attached to the pipe network 190 (including one or more pipe network sections 191 thereof). In other cases, a sensor device 560 may be a standalone component. In some cases, a sensor device 560 may include its own controller (e.g., controller 204), or portions thereof, which would make the sensor device 560 similar to a computer device discussed below with respect to FIG. 3.

Each sensor device 560 of the system 199 may be configured to provide sensor data 179 associated with the pipe network 190 (including one or more pipe network sections 191 thereof) using one or more communication links 102. The sensor data 179 associated with the pipe network 190 may be obtained from a sensor device 560 by the pipe network evaluation system 140 in one or more of a number of ways. For example, sensor data 179 may be obtained by the pipe network evaluation system 140 when a sensor device 560 responds to a request for the sensor data 179. Such a request may be made, for example, by the pipe network evaluation system 140, the network manager 180, a user 150 (including an associated user system 155), and/or some other entity within the system 199. As another example, sensor data 179 may be obtained by the pipe network evaluation system 140 when a sensor device 560 broadcasts the sensor data 179 without a specific recipient.

As yet another example, sensor data 179 may be obtained by the pipe network evaluation system 140 when a sensor device 560 sends the sensor data 179 in communications specifically addressed to the pipe network evaluation system 140. As still another example, sensor data 179 may be obtained by the pipe network evaluation system 140 when a user 150 (e.g., a government agency, an environmental consultant) physically obtains the sensor data 179 from a sensor device 560 (e.g., reads a display) and provides (e.g., scans a document, enters data into a template on a web portal) the sensor data 179 to the pipe network evaluation system 140.

As yet another example, sensor data 179 may be obtained by the pipe network evaluation system 140 from another component (e.g., the network manager 180, a user 150 (including an associated user system 155)) of the system 199, which obtains the sensor data 179, directly or indirectly, from one or more sensor devices 560 before providing the sensor data 179 to the pipe network evaluation system 140. In any case, the sensor data 179 for the pipe network 190 (including one or more pipe network sections 191 thereof) may be obtained from a sensor device 560 by the pipe network evaluation system 140 on a continuous basis, periodically (e.g., every 24 hours), as new sensor data 179 becomes available, randomly, and/or based on some other factor.

In some cases, any of the sensor devices (e.g., a sensor device 160, a sensor device 260, a sensor device 360, a sensor device 460, a sensor device 560, a sensor device 660) of the system 199 may include an energy storage device (e.g., a battery) to provide energy to allow the sensor device to operate. Any of the sensor devices may measure a parameter continuously, periodically, based on the occurrence of an event, based on a command received from the controller 204 of the pipe network evaluation system 140, and/or based on some other factor.

Each parameter measured by a sensor of any of the sensor devices of the system 199 may be sent from that sensor device to the controller 204 of the pipe network evaluation system 140 and/or another component of the respective data source (e.g., a pipe network design source 151, a monitored response data source 153, a manufacturing data source 171, an environmental data source 173, a fluid data source 175, an I&M data source 177) using one or more communication links (e.g., communication links 102).

In some cases, any of the sensor devices of the system 199 may be an integrated sensor. An integrated sensor has both the ability to sense and measure at least one parameter and the ability to communicate with another component (e.g., the controller 204 of the pipe network evaluation system 140, a user system 155). The communication capability of a sensor device that is an integrated sensor may include one or more communication devices that are configured to communicate with, for example, the controller 204 and/or another sensor device. For example, an integrated sensor device may include a sensor to measure one or more parameters and a transceiver that sends and receives communication signals using one or more communication links 102.

Each integrated sensor device may use one or more of a number of communication protocols. This allows the integrated sensor device to communicate with one or more components of the system 199. The communication capability of an integrated sensor device may be dedicated to the sensor device and/or shared with the controller 204 and/or one or more of the other sensor devices. If the communication capability of an integrated sensor device is dedicated to that sensor device, then the integrated sensor device may include one or more components (e.g., a transceiver, a communication module), or portions thereof, that are substantially similar to the corresponding components described below with respect to the controller 204.

In certain example embodiments, as discussed above, a sensor device of the system 199 may include an energy storage device (e.g., a battery) that is used to provide power, at least in part, to some or all of the sensor device. The optional energy storage device of the sensor module may operate at all times or when the sensor device is operating. Further, a sensor device may utilize or include one or more components (e.g., memory, storage repository, transceiver) found in the controller 204. In such a case, the controller 204 may provide the functionality of these components used by the sensor device. Alternatively, the sensor device may include, either on its own or in shared responsibility with the controller 204, one or more of the components of the controller 204.

A user 150 may be any person or entity that interacts with the system 199 or portions thereof. Examples of a user 150 may include, but are not limited to, a drilling engineer, a service engineer, a company representative, an inventory management system, an inventory manager, a roughneck, a labor scheduling system, a distributor, a technician, a certified welder, a software developer, a contractor, and a manufacturer's representative. A user 150 may use a user system 155 (also sometimes called a user device 155 herein), which may include a display (e.g., a GUI).

A user system 155 of a user 150 interacts with (e.g., sends data to, receives data from) the controller 204 of the pipe network evaluation system 140 via the application interface 226 (described below). Examples of a user system 155 may include, but are not limited to, a cell phone with an app, a laptop computer, a handheld device, a smart watch, a desktop computer, and an electronic tablet. In some cases, a user 150 (including an associated user system 155) may also interact with a network manager 180, one or more pipe network design sources 151, one or more monitored response data sources 153, one or more of the manufacturing data sources 171, one or more of the environmental data sources 173, one or more of the fluid data sources 175, one or more of the I&M data sources 177, and/or one or more of the sensor devices 560 in the system 199 using one or more communication links 102.

The network manager 180 is a device or component that controls all or a portion of a communication network that includes the controller 204 (including components thereof) of the pipe network evaluation system 140. The network manager 180 may be substantially similar to the controller 204 (discussed below). Alternatively, the network manager 180 may include one or more of a number of features in addition to, or altered from, the features of the controller 204 described below. As described herein, communication with the network manager 180 may include communicating with one or more other components (e.g., a user system 155) of the system 199. In such a case, the network manager 180 may facilitate such communication. There may be more than one network manager 180 and/or one or more portions of a network manager 180. The network manager 180 may also be called by other names in the art, including but not limited to a master controller, an enterprise manager, a system manager, and a system controller.

In certain example embodiments, the pipe network evaluation system 140 is configured to evaluate the pipe network 190 (including one or more pipe network sections 191 thereof) in real time. As discussed above, the various data (e.g., the design data 152, the monitored response data 154, the manufacturing data 172, the environmental data 174, the fluid data 176, the I&M data 178, and sensor data 179) received by the pipe network evaluation system 140 may be used to evaluate the pipe network 190 (including one or more pipe network sections 191 thereof) in real time. The pipe network evaluation system 140 may include one or more components. For example, as shown in FIG. 2, the pipe network evaluation system 140 includes a controller 204. The controller 204 of the pipe network evaluation system 140 may include one or more of a number of components or modules.

As shown in FIG. 2, such components or modules may include, but are not limited to, a control engine 206, a data evaluation module 225, a condition assessment module 223, a communication module 208, a timer 210, an energy metering module 211, a power module 212, a storage repository 230, a hardware processor 220, a memory 222, a transceiver 224, an application interface 226, and, optionally, a security module 228. The components of the controller 204 shown in FIG. 2 are not exhaustive. Any component of the example controller 204 may be discrete or combined with one or more other components of the controller 204. The controller 204 of the pipe network evaluation system 140 may be configured to operate automatically so that the integrity management (also referred to as evaluation herein) of the pipe network 190 (one or more including pipe network sections 191 thereof) is automated.

The controller 204 (or portions thereof) may be located indoors and/or outdoors with any of a number of types of environments (e.g., climate-controlled, humid, water-rated, corrosive, hazardous, office space). As an example, the controller 204 may be located on a platform of a floating structure used during a field operation, where the pipe network 190 (including one or more pipe network sections 191 thereof) may be in the form of a riser. As another example, the controller 204 (or portions thereof) may be located in an office located remotely from pipe network 190 (including one or more pipe network sections 191 thereof) in the form of a subsea pipeline. As yet another example, the controller 204 may be spread out over a number of locations (e.g., multiple offices) located remotely from pipe network 190 (including one or more pipe network sections 191 thereof) in the form of municipal water lines. As still another example, the controller 204 (or portions thereof) may be located onsite at a chemical plant where the pipe network 190 (including one or more pipe network sections 191 thereof) in the form of feed lines and processing lines.

The controller 204, a user 150 (including an associated user system 155), a sensor device 560, a pipe network design source 151, a monitored response data source 153, a manufacturing data source 171, an environmental data source 173, a fluid data source 175, an I&M data source 177, and/or the network manager 180 may use their own system or share a system in certain example embodiments. Such a system may be, or contain a form of, an Internet-based or an intranet-based computer system that is capable of communicating with various software. A computer system includes any type of computing device and/or communication device, including but not limited to the controller 204. Examples of such a system may include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system may correspond to a computer system as described below with regard to FIG. 3.

Further, as discussed above, such a system may have corresponding software (e.g., user software, network manager software). The software may execute on the same or a separate device (e.g., a server, mainframe, desktop personal computer (PC), laptop, PDA, television, cable box, satellite box, kiosk, telephone, mobile phone, or other computing devices) and may be coupled by the communication network (e.g., Internet, Intranet, Extranet, LAN, WAN, or other network communication methods) and/or communication channels, with wired and/or wireless segments according to some example embodiments. The software of one system may be a part of, or operate separately but in conjunction with, the software of another system within the system 199.

In certain example embodiments, the controller 204 of the system 199 is configured to use the design data 152 produced by the pipe network design sources 151, the monitored response data 154 produced by the monitored response data sources 153, the manufacturing data 172 produced by the manufacturing data sources 171, the environmental data 174 produced by the environmental data sources 173, the fluid data 176 produced by the fluid data sources 175, the I&M data 178 produced by the I&M data sources 177, and the sensor data 179 produced by the sensor devices 560 to evaluate the pipe network 190 (including one or more pipe network sections 191 thereof) in real time over the life of the pipe network 190 (including one or more pipe network sections 191 thereof). The controller 204 may also be configured to determine and communicate, in real time, a developing problem or failure of the pipe network 190 (or pipe network sections 191 thereof). The controller 204 may further be configured to employ a self-learning function by adjusting one or more algorithms 233 (discussed below) using recent data.

The storage repository 230 of the controller 204 may be a persistent storage device (or set of devices) that stores software and data used to assist the controller 204 in communicating with one or more of the users 150 (including any associated user systems 155), one or more of the pipe network design sources 151, one or more of the monitored response data sources 153, one or more of the manufacturing data sources 171, one or more of the environmental data sources 173, one or more of the fluid data sources 175, one or more of the I&M data sources 177, one or more of the sensor devices 560, and/or the network manager 180 within the system 199. In one or more example embodiments, the storage repository 230 stores one or more protocols 232, one or more algorithms 233, and stored data 234. The protocols 232 of the storage repository 230 may be any procedures (e.g., a series of method steps) and/or other similar operational procedures that the control engine 206 of the controller 204 follows based on certain conditions at a point in time.

An example of a protocol 232 is setting, evaluating, and possibly later adjusting, one or more thresholds as to when the pipe network 190 (including one or more pipe network sections 191 thereof) is determined to require maintenance, inspection, replacement, and/or some other course of action performed on it. Another example of a protocol 232 is a method for determining whether the measurements from certain sensor devices (e.g., sensor devices 160, sensor devices 260, sensor devices 360, sensor devices 460, sensor devices 560) should be utilized at a point in time (e.g., based on deviations from historical measurements, based on a lack of impact on the output of an algorithm 233).

The protocols 232 may include any of a number of communication protocols that are used to send and/or receive data between the controller 204 and a user 150 (including an associated user system 155), one or more of the pipe network design sources 151, one or more of the monitored response data sources 153, one or more of the manufacturing data sources 171, one or more of the environmental data sources 173, one or more of the fluid data sources 175, one or more of the I&M data sources 177, one or more of the sensor devices 560, and the network manager 180. A protocol 232 may also include a process for evaluating the pipe network 190 (including one or more pipe network sections 191 thereof) by the pipe network evaluation system 140 in real time. One or more of the protocols 232 may be a time-synchronized protocol. Examples of such time-synchronized protocols may include, but are not limited to, a highway addressable remote transducer (HART) protocol, a WirelessHART protocol, and an International Society of Automation (ISA) 100 protocol. In this way, one or more of the protocols 232 may provide a layer of security to the data transferred within the system 199.

The algorithms 233 of the storage repository 230 may be any formulas, mathematical models, forecasts, simulations, and/or other similar tools that the control engine 206 of the controller 204 uses to reach a computational conclusion. An example of one or more algorithms 233 may be or include a model that predicts a relationship between the condition of the pipe network 190 (including one or more pipe network sections 191 thereof) over time and data that originates from one or more of the pipe network design sources 151, one or more of the monitored response data sources 153, one or more of the manufacturing data sources 171, one or more of the environmental data sources 173, one or more of the fluid data sources 175, one or more of the I&M data sources 177, and/or one or more of the sensor devices 560.

As another example, one or more algorithms 233 may be or include a model that is used to evaluate, in real time, portions of the pipe network 190 (including one or more pipe network sections 191 thereof) using data that originates from one or more of the pipe network design sources 151, one or more of the monitored response data sources 153, one or more of the manufacturing data sources 171, one or more of the environmental data sources 173, one or more of the fluid data sources 175, one or more of the I&M data sources 177, and/or one or more of the sensor devices 560. As yet another example, one or more algorithms 233 may be used to identify suggested changes to one or more of the pipe network design sources 151 as to how the one or more of the pipe network design sources 151 design future pipe networks 190 (including one or more pipe network sections 191 thereof).

Algorithms 233 may be used to analyze past data, analyze current data, and/or perform forecasts. One or more of the algorithms 233 may be developed specifically for the pipe network 190, including any pipe network sections 191 thereof. An algorithm 233 may be fixed or modified (e.g., by a user 150, by the control engine 206) over time. Modification of an algorithm 233 may be based on one or more of a number of factors, including but not limited to correction based on actual data that originates from one or more of the pipe network design sources 151, one or more of the monitored response data sources 153, one or more of the manufacturing data sources 171, one or more of the environmental data sources 173, one or more of the fluid data sources 175, one or more of the I&M data sources 177, and/or one or more of the sensor devices 560, input from a user 150 or associated user system 155, changes in a protocol 232, and changes in a related algorithm 233.

Stored data 234 of the storage repository 230 may be any data (e.g., material, thickness, length, manufacturing information) associated with the pipe network 190 (including one or more pipe network sections 191 thereof), any measurements made by any of the sensor devices (e.g., sensor device 160, sensor device 260, sensor device 560), any other information that originates from a data source (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), threshold values, look-up tables, results of previously run or calculated algorithms 233, user preferences, and/or any other suitable data. Such data may be any type of data, including but not limited to historical data, current data, and forecasts. The stored data 234 may be associated with some measurement of time derived, for example, from the timer 210.

Examples of a storage repository 230 may include, but are not limited to, a database (or a number of databases), a file system, a hard drive, flash memory, some other form of solid state data storage, cloud-based storage, or any suitable combination thereof. The storage repository 230 may be located on multiple physical machines (e.g., the controller 204, the network manager 180, the cloud), each storing all or a portion of the protocols 232, the algorithms 233, and/or the stored data 234 according to some example embodiments. Each storage unit or device may be physically located in the same or in a different geographic location.

The storage repository 230 may be operatively connected to the control engine 206. In one or more example embodiments, the control engine 206 includes functionality to communicate with a user 150 (including an associated user system 155), one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), one or more of the sensor devices 560, and/or the network manager 180 in the system 199. More specifically, the control engine 206 sends information to and/or receives information from the storage repository 230 in order to communicate with a user 150 (including an associated user system 155), one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), one or more of the sensor devices 560, and/or the network manager 180. As discussed below, the storage repository 230 may also be operatively connected to the communication module 208 in certain example embodiments.

In certain example embodiments, the control engine 206 of the controller 204 controls the operation of one or more components (e.g., the communication module 208, the timer 210, the transceiver 224) of the controller 204. For example, the control engine 206 may activate the communication module 208 when the communication module 208 is in “sleep” mode and when the communication module 208 is needed to send data received from another component (e.g., a user system 155 of a user 150, a sensor device 560, a fluid data source 175) in the system 199.

As another example, the control engine 206 may acquire the current time using the timer 210. As yet another example, the control engine 206 may direct the energy metering module 211 to measure and send power consumption information to the network manager 180. As still another example, the control engine 206 of the controller 204 may use measurements made by the sensor devices 560 and/or information that originates from one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), to generate an output of one or more algorithms 233.

The control engine 206 may be configured to perform a number of functions that help the controller 204 evaluate the pipe network 190 (including one or more pipe network sections 191 thereof) in real time over an extended period of time (e.g., 6 months, a year, 10 years, 100 years, 250 years). As discussed above, the control engine 206 may execute any of the protocols 232 and/or the algorithms 233, using stored data 234 stored in the storage repository 230, to automatically evaluate the pipe network 190 (including one or more pipe network sections 191 thereof) in real time. In certain example embodiments, the control engine 206 controls the frequency at which information that originates from one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) and/or one or more of the sensor devices 560 is obtained.

The control engine 206 may use one or more of the algorithms 233 and/or protocols 232 to predict a relationship between certain data obtained from a data source (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) and/or the sensor devices 560 and the pipe network 190 (including one or more pipe network sections 191 thereof) over time. As another example, the control engine 206 may use one or more of the algorithms 233 and/or protocols 232 to assess/evaluate the data obtained from a data source (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) and/or the sensor devices 560. As another example, the control engine 206 may use one or more of the algorithms 233 and/or protocols 232 to discard or filter out, in real time, particular data obtained from one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) and/or the sensor devices 560 that are deemed to be erroneous or otherwise unusable.

As still another example, the control engine 206 may use one or more of the algorithms 233 and/or protocols 232 to prepare (e.g., clean, normalize) raw data obtained from one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) and/or the sensor devices 560 so that such data is usable in evaluating the pipe network 190 (including one or more pipe network sections 191 thereof). As yet another example, the control engine 206 may evaluate and, if necessary, adjust one or more of the algorithms 233 and/or protocols 232 to more accurately evaluate the pipe network 190 (including one or more pipe network sections 191 thereof).

In certain example embodiments, the control engine 206 of the controller 204 may use one or more of the algorithms 233 and/or protocols 232 to verify the functionality of one or more of the sensor devices (e.g., a sensor device 160, a sensor device 260, a sensor device 560), either before or during a field operation. This functionality of a sensor device may be directed to a specific component (e.g., a sensor) of the sensor device or cover a full spectrum of the functional capability of the sensor device. In performing this function, the control engine 206 may perform calibrations and/or establish settings of a sensor device or one or more of its components. For example, the control engine 206 may calibrate a sensor device that measures wind speed. As another example, the control engine 206 may test and upload settings (e.g., detection settings, actions to take upon detecting a certain parameter that exceeds or falls below a threshold value, hold time, actions to take when failing to detect a parameter) with respect to a sensor device that measures a parameter associated with the pipe network 190 (including one or more pipe network sections 191 thereof).

The control engine 206 of the controller 204, through the use of one or more protocols 232 and/or algorithms 233, may implement machine learning as a way to evolve over time with new data and associated changes that may result from the new data. The control engine 206 may use, for example, supervised learning, unsupervised learning, semi-supervised learning, and/or reinforcement learning, as those terms are known in the art of machine learning. In this case, these types of machine learning are effective with sufficient data (e.g., measurements from sensor devices 560, other data obtained from one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177)) and use of algorithms 233 that automatically build mathematical models using sample data—also known as “training data”.

The learning algorithms 233 that may be used and trained by the control engine 206 may include, but are not limited to, instance-based learning algorithms, artificial neural network algorithms, deep learning algorithms, and ensemble algorithms. Instance-based learning algorithms typically build up a database of example data and compare new data to the database using a similarity measure in order to find the best match and make a prediction. For this reason, instance-based methods are also called winner-take-all methods and memory-based learning. Focus may be put on the representation of the stored instances and similarity measures used between instances. Instance-based algorithms may be computationally expensive for very large datasets since they save all training instances/data points and are sensitive to data noise.

Artificial neural networks may be fairly similar to the human brain. For example, artificial neural networks may be made up of artificial neurons, take in multiple inputs, and produce specific outputs. Artificial neural networks may be an enormous subfield comprised of a large number of neural network architectures and hundreds of algorithms and variations for different types of problems. Artificial neural networks may be biologically inspired computational simulations for certain specific tasks like clustering, classification, or pattern recognition.

Deep learning algorithms may be a modern update to artificial neural networks by building much larger and more complex neural networks. With deep learning, many methods may be applied to very large datasets. Various architectures may be applied for deep learning algorithms. Deep learning may have a high computational cost because much of its development requires advanced processing, storage hardware, and ML platforms/APIs.

Ensemble algorithm methods may be models composed of multiple weaker models that are independently trained and whose predictions are combined in some way to make the overall prediction. Various combination techniques (e.g., averaging, max voting, bagging/bootstrapping (sampling subsets of original complete dataset), boosting) may be applied. Unlike other standard ensemble methods where models are trained in isolation, the boosting technique may employ an iterative approach, training models in succession, with each new model being trained to correct the errors made by the previous ones. Models may be added sequentially until no further improvements may be made.

The control engine 206 may cause control, communication, and/or other similar signals to be generated and sent to a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. Similarly, the control engine 206 may execute certain instructions based on control, communication, and/or other similar signals received from a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. The control engine 206 may control each sensor device 560 and/or each data source (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177) automatically (for example, based on one or more protocols 232 or algorithms 233 stored in the storage repository 230) and/or based on control, communication, and/or other similar signals received from another device or component of the system 199 through a communication link 102.

In certain embodiments, the control engine 206 of the controller 204 may communicate with one or more components of a system external to the system 199 in furtherance of evaluating the pipe network 190 (including one or more pipe network sections 191 thereof) in real time. For example, the control engine 206 may interact with an inventory management system by ordering a replacement component (e.g., a sensor device 560, a fitting) of the system 199 when the control engine 206 has determined that the component has failed or is about to fail. As another example, the control engine 206 may interact with a logistics system by scheduling one or more modes of transportation (e.g., truck, train, helicopter, boat) to get a replacement component to the site of the field operation so that the component may be replaced. In this way, the controller 204 is capable of performing a number of functions beyond what is performed within the system 199 shown in FIG. 1.

A user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180 may interact with the controller 204 using the application interface 226 and the communication links 102 in accordance with one or more example embodiments. Specifically, the application interface 226 of the controller 204 receives data (e.g., information, communications, instructions, updates to firmware) from and sends data (e.g., information, communications, instructions) to a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. In certain example embodiments, the application interface 226 may be or include a dashboard that provides information to a user 150 (including an associated user system 155) and/or receives input from a user 150 (including an associated user system 155).

A user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180 may include an interface to receive data from and send data to the controller 204 in certain example embodiments. Examples of such an interface may include, but are not limited to, a graphical user interface, a touchscreen, an application programming interface, a keyboard, a monitor, a mouse, a web service, a data protocol adapter, some other hardware and/or software, or any suitable combination thereof.

In some cases, the application interface 226 of the controller 204 may enable the control engine 206 to communicate with one or more components (e.g., a sensor device 560, the network manager 180, an environmental data source 173) of the system 199 using a particular interface. For example, if the controller 204 operates under IEC Standard 62386, then the controller 204 may have a serial communication interface that will transfer data (e.g., stored data 234) measured by one or more of the sensor devices 560. In such a case, a user system 155 may also include a serial interface to enable communication with the controller 204. Such an interface may operate in conjunction with, or independently of, the protocols 232 used to communicate between the controller 204 and a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or, the network manager 180.

The control engine 206 (or other components of the controller 204) may also include one or more hardware components and/or software elements to perform its functions. Such components may include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The data evaluation module 225 of the controller 204 of the pipe network evaluation system 140 is configured to evaluate some or all of the data (e.g., manufacturing data 172, environmental data 174, fluid data 176, I&M data 178, sensor data 179) obtained by the controller 204 from the various data sources (e.g., the one or more of the pipe network design sources 151, the one or more of the monitored response data sources 153, the one or more manufacturing data sources 171, the one or more environmental data sources 173, the one or more fluid data sources 175, the one or more I&M data sources 177, the one or more optional sensor devices 560).

In certain example embodiments, The data evaluation module 225 of the controller 204 may evaluate the design data 152, the monitored response data 154, the manufacturing data 172, the environmental data 174, the fluid data 176, the I&M data 178, and the optional sensor data 179 using the communication module 208, one or more protocols 232, one or more algorithms 233, and/or stored data 234. The data evaluation module 225 of the controller 204 may evaluate the design data 152, the monitored response data 154, the manufacturing data 172, the environmental data 174, the fluid data 176, the I&M data 178, and the optional sensor data 179 continually, periodically (e.g., every minute, every hour, every 24 hours, weekly, monthly), on the occurrence of an event (e.g., obtaining new data (e.g., new design data 152, new monitored response data 154, new environmental data 174, new fluid data 176, new I&M data 178), randomly, and/or on some other basis. Evaluating the manufacturing data 172, the environmental data 174, the fluid data 176, the I&M data 178, and the optional sensor data 179 may include filtering, formatting, grouping, averaging, organizing, validating, and/or otherwise processing some or all of the data obtained by the controller 204. As an example, the data evaluation module 225 may use welding flaw information that is part of the manufacturing data 172, in conjunction with monitored response data 154, one or more algorithms 233, one or more protocols 232, and stored data 234, to redefine (e.g., increase, decrease) a useful life of the pipe network 190 (or one or more pipe network sections 191 thereof).

The condition assessment module 223 of the controller 204 of the pipe network evaluation system 140 is configured to assess the condition of the pipe network 190 (including one or more pipe network sections 191 thereof). The condition assessment module 223 may assess the condition of the pipe network 190 (including one or more pipe network sections 191 thereof) using the data (e.g., design data 152, monitored response data 154, manufacturing data 172, environmental data 174, fluid data 176, I&M data 178, sensor data 179) obtained by the controller 204 after the data is evaluated by the data evaluation module 225. In addition, the condition assessment module 223 may assess the condition of the pipe network 190 (including one or more pipe network sections 191 thereof) using the communication module 208, one or more protocols 232, one or more algorithms 233, and/or stored data 234.

The condition assessment module 223 of the controller 204 may assess the condition of the pipe network 190 (including one or more pipe network sections 191 thereof) continually, periodically (e.g., every minute, every hour, every 24 hours, weekly, monthly), on the occurrence of an event (e.g., obtaining new data (e.g., new environmental data 174, new fluid data 176, new I&M data 178), randomly, and/or on some other basis. The condition assessment module 223 may assess a current condition of the pipe network 190 (including one or more pipe network sections 191 thereof). In addition, or in the alternative, the condition assessment module 223 may assess a future current condition of the pipe network 190 (including one or more pipe network sections 191 thereof) based on trends tracked over time by the condition assessment module 223.

In certain example embodiments, assessment generated by the condition assessment module 223 may have any of a number of scopes. For example, the condition assessment module 223 may identify particular pipe network sections 191 that are having problems and/or failures, while also identifying the specific problems (e.g., external corrosion, internal erosion, cracking) and/or failures. As another example, additionally or alternatively, the condition assessment module 223 may suggest specific actions that may be taken with respect to particular pipe network sections 191 to prevent a failure from occurring. As yet another example, additionally or alternatively, the condition assessment module 223 may predict or forecast when a failure will occur to one or more particular pipe network sections 191 if no corrective action is taken.

As still another example, additionally or alternatively, the condition assessment module 223 may send instructions to the control engine 206 of the controller 204 so that the control engine 206 may control certain equipment (e.g., a valve, a motor, a heater, a fan) that may isolate an identified failure in the pipe network 190. As yet another example, additionally or alternatively, the condition assessment module 223 may send instructions to the control engine 206 of the controller 204 so that the control engine 206 may control certain equipment (e.g., a valve, a motor, a heater, a fan) that may reduce or eliminate a condition that is causing a deterioration or failure of one or more pipe network sections 191 in the pipe network 190.

In certain example embodiments, the condition assessment module 223 may generate one or more of a number of outputs. Examples of such outputs may include, but are not limited to, a detailed report (e.g., in an email, in text on a display, in an audio file that is broadcast over a speaker, in a text message), an alarm (e.g., a flashing indicating light, a siren), an automated phone recording tailored to the issue, scheduling labor with employees and/or contractors, and purchasing needed parts from vendors.

The communication module 208 of the controller 204 determines and implements the communication protocol (e.g., from the protocols 232 of the storage repository 230) that is used when the control engine 206 communicates with (e.g., sends signals to, receives signals from) a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. In some cases, the communication module 208 accesses the stored data 234 to determine which communication protocol is used to communicate with another component of the system 199. In addition, the communication module 208 may interpret the communication protocol of a communication received by the controller 204 so that the control engine 206 may interpret the communication.

The communication module 208 may send and receive data between the network manager 180, the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the users 150 (including associated user systems 155) and the controller 204. The communication module 208 may send and/or receive data in a given format that follows a particular protocol 232. The control engine 206 may interpret the data packet received from the communication module 208 using the protocol 232 information stored in the storage repository 230. The control engine 206 may also facilitate the data transfer between one or more sensor devices 560 and the network manager 180, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or a user 150 (including an associated user system 155) by converting the data into a format understood by the communication module 208.

The communication module 208 may send data (e.g., protocols 232, algorithms 233, stored data 234, operational information, threshold values, results of algorithms 233) directly to and/or retrieve data directly from the storage repository 230. Alternatively, the control engine 206 may facilitate the transfer of data between the communication module 208 and the storage repository 230. The communication module 208 may also provide encryption to data that is sent by the controller 204 and decryption to data that is received by the controller 204. The communication module 208 may also provide one or more of a number of other services with respect to data sent from and received by the controller 204. Such services may include, but are not limited to, data packet routing information and procedures to follow in the event of data interruption.

The timer 210 of the controller 204 may track clock time, intervals of time, an amount of time, and/or any other measure of time. The timer 210 may also count the number of occurrences of an event, whether with or without respect to time. Alternatively, the control engine 206 may perform the counting function. The timer 210 is able to track multiple time measurements concurrently. The timer 210 may track time periods based on an instruction received from the control engine 206, based on an instruction received from the user 150 (or an associated user system 155), based on an instruction programmed in the software for the controller 204, based on some other condition or from some other component, or from any combination thereof.

The timer 210 may be configured to track time when there is no power delivered to the controller 204 (e.g., the power module 212 malfunctions) using, for example, a super capacitor or a battery backup. In such a case, when there is a resumption of power delivery to the controller 204, the timer 210 may communicate any aspect of time to the controller 204. In such a case, the timer 210 may include one or more of a number of components (e.g., a super capacitor, an integrated circuit) to perform these functions.

The energy metering module 211 of the controller 204 measures one or more components of energy (e.g., electrical current, electrical voltage, resistance, VARs, watts) at one or more points within the scope of the controller 204. The energy metering module 211 may include any of a number of measuring devices and related devices, including but not limited to a voltmeter, an infrared detector, an ammeter, a power meter, an ohmmeter, a current transformer, a potential transformer, a sensing resistor, and electrical wiring. The energy metering module 211 may measure a component of energy continuously, periodically, based on the occurrence of an event, based on a command received from the control engine 206, and/or based on some other factor. The energy metering module 211 may be part of, or separate from, the sensor devices 560. Measurements made by the energy metering module 211 may be used by the control engine 206 to determine whether other parts or components of the controller 204 are functioning properly.

The power module 212 of the controller 204 provides power to one or more other components (e.g., timer 210, control engine 206) of the controller 204. The power module 212 may include one or more of a number of single or multiple discrete components (e.g., transistor, diode, resistor), and/or a microprocessor. The power module 212 may include a printed circuit board, upon which the microprocessor and/or one or more discrete components are positioned. In some cases, the power module 212 may include one or more components that allow the power module 212 to measure one or more elements of power (e.g., voltage, current) that is delivered to and/or sent from the power module 212. Alternatively, the energy metering module 211 may measure one or more elements of power that flows into, out of, and/or within the power module 212.

The power module 212 may include one or more components (e.g., a transformer, a diode bridge, an inverter, a converter) that receives power (for example, through an electrical cable) from a source external to the controller 204 and generates power of a type (e.g., alternating current, direct current) and level (e.g., 12V, 24V, 120V) that may be used by the other components of the controller 204. The power module 212 may use a closed control loop to maintain a preconfigured voltage or current with a tight tolerance at the output. The power module 212 may also protect the rest of the electronics (e.g., hardware processor 220, transceiver 224) of the controller 204 from surges generated in the line.

In addition, or in the alternative, the power module 212 may be or include a source of power in itself to provide signals to the other components of the controller 204. For example, the power module 212 may be or include a battery. As another example, the power module 212 may be or include a localized photovoltaic power system. The power module 212 may also have sufficient isolation in the associated components of the power module 212 (e.g., transformers, opto-couplers, current and voltage limiting devices) so that the power module 212 is certified to provide power to an intrinsically safe circuit.

In certain example embodiments, the power module 212 of the controller 204 may also provide power and/or control signals, directly or indirectly, to one or more of the sensor devices 560. In such a case, the control engine 206 may direct the power generated by the power module 212 to one or more of the sensor devices 560. In this way, power may be conserved by sending power to the sensor devices 560 when the sensor devices 560 need power, as determined by the control engine 206.

The hardware processor 220 of the controller 204 executes software, algorithms (algorithms 233), and firmware in accordance with one or more example embodiments. Specifically, the hardware processor 220 may execute software on the control engine 206 or any other portion of the controller 204, as well as software used by a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. The hardware processor 220 may be an integrated circuit, a central processing unit, a multi-core processing chip, SoC, a multi-chip module including multiple multi-core processing chips, or other hardware processor in one or more example embodiments. The hardware processor 220 is known by other names, including but not limited to a computer processor, a microprocessor, a microcontroller, and a multi-core processor.

In one or more example embodiments, the hardware processor 220 executes software instructions stored in memory 222. The memory 222 includes one or more cache memories, main memory, and/or any other suitable type of memory. The memory 222 may include volatile and/or non-volatile memory. The memory 222 is discretely located within the controller 204 relative to the hardware processor 220 according to some example embodiments. In certain configurations, the memory 222 may be integrated with the hardware processor 220.

In certain example embodiments, the controller 204 does not include a hardware processor 220. In such a case, the controller 204 may include, as an example, one or more field programmable gate arrays (FPGA), one or more integrated-gate bipolar transistors (IGBTs), one or more complex programmable logic devices (CPLDs), programmable array logics (PALs), one or more digital signal processors (DSPs), and/or one or more integrated circuits (ICs). Using FPGAs, IGBTs, CPLDs, PALs, DSPs, ICs, and/or other similar devices known in the art allows the controller 204 (or portions thereof) to be programmable and function according to certain logic rules and thresholds without the use of a hardware processor. Alternatively, FPGAs, IGBTs, CPLDs, PALs, DSPs, ICs, and/or similar devices may be used in conjunction with one or more hardware processors 220.

The transceiver 224 of the controller 204 may send and/or receive control and/or communication signals. Specifically, the transceiver 224 may be used to transfer data between the controller 204 and a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. The transceiver 224 may use wired and/or wireless technology. The transceiver 224 may be configured in such a way that the control and/or communication signals sent and/or received by the transceiver 224 may be received and/or sent by another transceiver that is part of a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or, the network manager 180. The transceiver 224 may use any of a number of signal types, including but not limited to radio frequency signals.

When the transceiver 224 uses wireless technology, any type of wireless technology may be used by the transceiver 224 in sending and receiving signals. Such wireless technology may include, but is not limited to, Wi-Fi, visible light communication (VLC), cellular networking, 802.15.4 wireless, ZigBee, 4G cellular wireless, BLE, and Bluetooth. The transceiver 224 may use one or more of any number of suitable communication protocols (e.g., ISA100, HART) when sending and/or receiving signals. Such communication protocols may be stored in the protocols 232 of the storage repository 230. Further, any transceiver information for a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180 may be part of the stored data 234 (or similar areas) of the storage repository 230.

Optionally, in one or more example embodiments, the security module 228 secures interactions between the controller 204, a user 150 (including an associated user system 155), one or more of the sensor devices 560, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the network manager 180. More specifically, the security module 228 authenticates communication from software based on security keys verifying the identity of the source of the communication. For example, user software may be associated with a security key enabling the software of a user system 155 of a user 150 to interact with the controller 204, the network manager 180, one or more of the data sources (e.g., one or more of the pipe network design sources 151, one or more of the monitored response data sources 153, one or more of the manufacturing data sources 171, one or more of the environmental data sources 173, one or more of the fluid data sources 175, one or more of the I&M data sources 177), and/or the sensor devices 560. Further, the security module 228 may restrict receipt of information, requests for information, and/or access to information in some example embodiments.

FIG. 3 shows a computer device 318 according to certain example embodiments. FIG. 3 illustrates one embodiment of a computer device 318 that implements one or more of the various techniques described herein, and which is representative, in whole or in part, of the elements described herein pursuant to certain exemplary embodiments. For example, computer device 318 may be implemented in the form of the controller 204 (which may include the hardware processor 220, memory 222, and a storage repository 230, among other components) of FIG. 2. Computer device 318 is one example of a computing device and is not intended to suggest any limitation as to scope of use or functionality of the computing device and/or its possible architectures. Neither should computer device 318 be interpreted as having any dependency or requirement relating to any one or combination of components illustrated in the example computer device 318.

Computer device 318 includes one or more processors or processing units 314, one or more memory/storage components 315, one or more input/output (I/O) devices 316, and a bus 317 that allows the various components and devices to communicate with one another. Bus 317 represents one or more of any of several types of bus structures, including a memory bus or memory controller, a peripheral bus, an accelerated graphics port, and a processor or local bus using any of a variety of bus architectures. Bus 317 includes wired and/or wireless buses.

Memory/storage component 315 represents one or more computer storage media. Memory/storage component 315 includes volatile media (such as random access memory (RAM)) and/or nonvolatile media (such as read only memory (ROM), flash memory, optical disks, magnetic disks, and so forth). Memory/storage component 315 includes fixed media (e.g., RAM, ROM, a fixed hard drive, etc.) as well as removable media (e.g., a Flash memory drive, a removable hard drive, an optical disk, and so forth).

One or more I/O devices 316 allow a customer, utility, or other user to enter commands and information to computer device 318, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 318 is connected to a network (not shown) (e.g., a LAN, a WAN such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 318 includes at least the minimal processing, input, and/or output means necessary to practice one or more embodiments.

Further, those skilled in the art will appreciate that one or more elements of the aforementioned computer device 318 is located at a remote location and connected to the other elements over a network in certain exemplary embodiments. Further, one or more embodiments may be implemented on a distributed system having one or more nodes, where each portion of the implementation (e.g., control engine 206) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

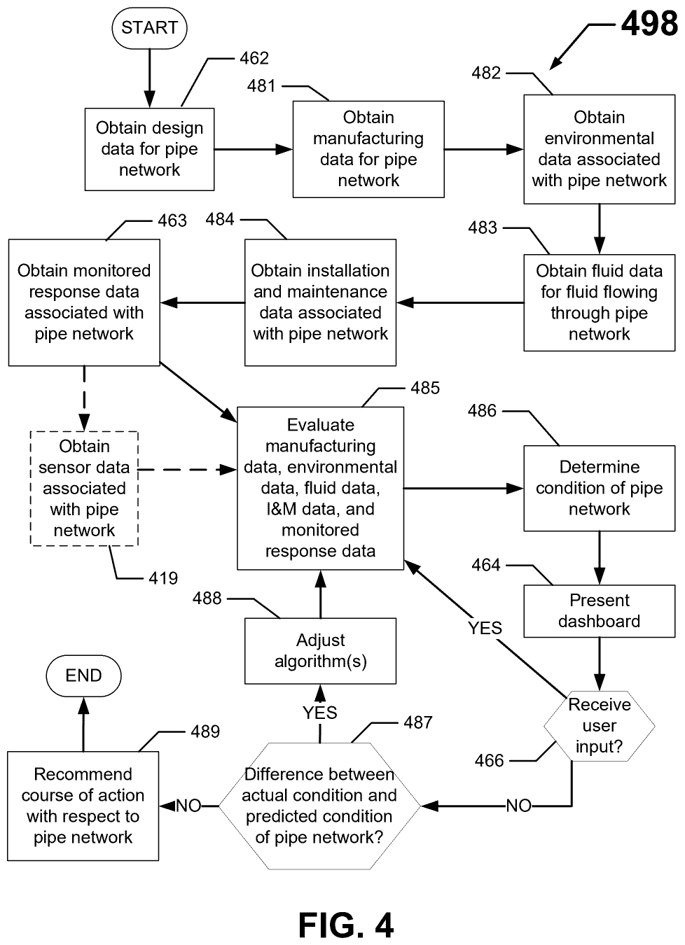

FIG. 4 shows a flowchart 498 of a method for evaluating pipe networks in service according to certain example embodiments. While the various steps in this flowchart 498 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 4 may be included in performing this method. Accordingly, the specific arrangement of steps should not be construed as limiting the scope of the method for evaluating a pipe network in service according to certain example embodiments. Further, a particular computing device, such as the computing device discussed above with respect to FIG. 3, may be used to perform one or more of the steps for the methods shown in FIG. 4 in certain example embodiments. Any of the functions performed below by the controller 204 may involve the use of one or more protocols 232, one or more algorithms 233, and/or stored data 234.

The method shown in FIG. 4 is merely an example that may be performed by using an example system described herein. In other words, systems for evaluating a pipe network in service may perform other functions using other methods in addition to and/or aside from those shown in FIG. 4. Referring to the description above with respect to FIGS. 1 through 3, the method shown in the flowchart 498 of FIG. 4 begins at the START step and proceeds to step 462, where design data 152 for the pipe network 190 (including one or more pipe network sections 191 thereof) is obtained. In some cases, the design data 152 is additionally associated with ancillary equipment used to physically and/or operationally support the pipe network 190 (including one or more pipe network sections 191 thereof). The design data 152 may be obtained from one or more pipe network design sources 151 using communication links 102. The design data 152 may be obtained by the controller 204 of the pipe network evaluation system 140 using the application interface 226, the communication module 208, one or more protocols 232, and/or one or more algorithms 233. Some or all of the design data 152 may be stored by the controller 204 of the pipe network evaluation system 140 as stored data 234. The design data 152 may be obtained at any interval (e.g., instantaneously, continuously, periodically, randomly).

As discussed above, the design data 152 for the pipe network 190 (including one or more pipe network sections 191 thereof) obtained, directly or indirectly, from a pipe network design source 151 may be any data associated with the design of the pipe network 190 (including one or more pipe network sections 191 thereof). In some cases, additionally, the design data 152 for the pipe network 190 (including one or more pipe network sections 191 thereof) obtained, directly or indirectly, from a pipe network design source 151 may be any design data associated with some or all of the ancillary equipment (brackets, hangers, insulation, grounding capability, pumps, compressors) used to physically and/or operationally support the pipe network 190 (including one or more pipe network sections 191 thereof). Design data 152 obtained by the controller 204 may have GPS data and/or other locational information that allows the controller 204 to associate the design data 152 with one or more pipe network sections 191 of the pipe network 190.

Examples of the design data 152 may include, but are not limited to, the material of the pipe network 190 (including one or more pipe network sections 191 thereof), the specific composition of the material of the pipe network 190 (including one or more pipe network sections 191 thereof), the inner diameter (ID) of one or more components of the pipe network 190 (including one or more pipe network sections 191 thereof), the outer diameter (OD) of one or more components of the pipe network 190 (including one or more pipe network sections 191 thereof), the thickness of one or more components of the pipe network 190 (including one or more pipe network sections 191 thereof), the tolerance of the thickness of one or more components of the pipe network 190 (including one or more pipe network sections 191 thereof), the length of one or more components of the pipe network 190 (including one or more pipe network sections 191 thereof), the curvature of one or more components of the pipe network 190 (including one or more pipe network sections 191 thereof), the coupling features (e.g., mating threads) used to assemble of the pipe network 190 (including one or more pipe network sections 191 thereof), welding specifications, budgets (e.g., financial, performance), details (e.g., thread size) about the coupling features of the pipe network 190 (including one or more pipe network sections 191 thereof), the temperature rating of one or more components of the pipe network 190 (including one or more pipe network sections 191 thereof), the pressure rating of one or more components of the pipe network 190 (including one or more pipe network sections 191 thereof), and characteristics (e.g., material, thickness) of any coating (e.g., insulating jacket, a spray-on layer) on a surface (e.g., inner surface, outer surface) of one or more components of the pipe network 190 (including one or more pipe network sections 191 thereof).

In 481, manufacturing data 172 for the pipe network 190 (including one or more pipe network sections 191 thereof) is obtained. In some cases, the manufacturing data 172 is additionally associated with ancillary equipment used to physically and/or operationally support the pipe network 190 (including one or more pipe network sections 191 thereof). The manufacturing data 172 may be obtained from one or more manufacturing data sources 171 using communication links 102. The manufacturing data 172 may be obtained by the controller 204 of the pipe network evaluation system 140 using the application interface 226, the communication module 208, one or more protocols 232, and/or one or more algorithms 233. Some or all of the manufacturing data 172 may be stored by the controller 204 of the pipe network evaluation system 140 as stored data 234. The manufacturing data 172 may be obtained at any interval (e.g., instantaneously, continuously, periodically, randomly). The manufacturing data 172 may cover a period of time (e.g., an hour, a day, a week, a month, a year).

As discussed above, the manufacturing data 172 for the pipe network 190 (including one or more pipe network sections 191 thereof) obtained, directly or indirectly, from a manufacturing data source 171 may be any data associated with manufacturing the pipe network 190 (including one or more pipe network sections 191 thereof). In some cases, additionally, the manufacturing data 172 for the pipe network 190 (including one or more pipe network sections 191 thereof) obtained, directly or indirectly, from a manufacturing data source 171 may be any data associated with some or all of the ancillary equipment (brackets, hangers, insulation, grounding capability, pumps, compressors) used to physically and/or operationally support the pipe network 190 (including one or more pipe network sections 191 thereof). Manufacturing data 172 obtained by the controller 204 may have GPS data and/or other locational information that allows the controller 204 to associate the manufacturing data 172 with one or more pipe network sections 191 of the pipe network 190.

Examples of the manufacturing data 172 may include, but are not limited to, the material of the pipe network 190 (including one or more pipe network sections 191 thereof), the specific composition of the material of the pipe network 190 (including one or more pipe network sections 191 thereof), the inner diameter (ID) of one or more components of the pipe network 190 (including one or more pipe network sections 191 thereof), the outer diameter (OD) of one or more components of the pipe network 190 (including one or more pipe network sections 191 thereof), the thickness of one or more components of the pipe network 190 (including one or more pipe network sections 191 thereof), the tolerance of the thickness of one or more components of the pipe network 190 (including one or more pipe network sections 191 thereof), the length of one or more components of the pipe network 190 (including one or more pipe network sections 191 thereof), the curvature of one or more components of the pipe network 190 (including one or more pipe network sections 191 thereof), the coupling features (e.g., mating threads) used to assemble of the pipe network 190 (including one or more pipe network sections 191 thereof), details (e.g., thread size) about the coupling features of the pipe network 190 (including one or more pipe network sections 191 thereof), the temperature rating of one or more components of the pipe network 190 (including one or more pipe network sections 191 thereof), the pressure rating of one or more components of the pipe network 190 (including one or more pipe network sections 191 thereof), and characteristics (e.g., material, thickness) of any coating (e.g., insulating jacket, a spray-on layer) on a surface (e.g., inner surface, outer surface) of one or more components of the pipe network 190 (including one or more pipe network sections 191 thereof). In some cases, at least some of the manufacturing data 172 for the pipe network 190 (including one or more pipe network sections 191 thereof) is listed on a nameplate and/or spec sheet for the pipe network 190 (including one or more pipe network sections 191 thereof).

In step 482, environmental data 174 associated with the pipe network 190 (including one or more pipe network sections 191 thereof) is obtained. Specifically, the environmental data 174 may be associated with the environment 194 in which the pipe network 190 (including one or more pipe network sections 191 thereof) is located. In some cases, the environmental data 174 is additionally associated with the environment 194 in which ancillary equipment used to physically and/or operationally support the pipe network 190 (including one or more pipe network sections 191 thereof) is located. The environmental data 174 may be obtained from one or more environmental data sources 173 using communication links 102. The environmental data 174 may be obtained by the controller 204 of the pipe network evaluation system 140 using the application interface 226, the communication module 208, one or more protocols 232, and/or one or more algorithms 233. Some or all of the environmental data 174 may be stored by the controller 204 of the pipe network evaluation system 140 as stored data 234. The environmental data 174 may be obtained at any interval (e.g., instantaneously, continuously, periodically, randomly). The environmental data 174 may cover a period of time (e.g., an hour, a day, a week, a month, a year).

As discussed above, the environmental data 174 for the pipe network 190 may be any data associated with the environment 194 for one or more locations in which the pipe network 190 (including one or more pipe network sections 191 thereof) is placed and/or to which the pipe network 190 (including one or more pipe network sections 191 thereof) is exposed. Examples of environmental data 174 may include, but are not limited to, air content, moisture content, water content, soil content, humidity (e.g., individual humidity values, a range of humidity values) data, time stamps for applicable fluid environments (e.g., in-air, sour, acid) and associated temperature and pressure conditions, in-field pressure/temperature monitoring data (e.g., collected at useful intervals and locations), the medium data (e.g., metocean data, which may include any data that is associated with wind, wave, and/or climate conditions that may affect the pipe network 190 under water) associated with the medium (e.g., sea water, fresh water, soil, ambient air) in which the pipe network 190 (including one or more pipe network sections 191 thereof) is placed, temperature (e.g., individual temperatures, a range of temperatures) data, wind data, current data (e.g., for water flow), vibration data, and pressure data (e.g., atmospheric pressure). Environmental data 174 obtained by the controller 204 may have GPS data and/or other locational information that allows the controller 204 to associate the environmental data 174 with one or more pipe network sections 191 of the pipe network 190.

In step 483, fluid data 176 associated with the pipe network 190 (including one or more pipe network sections 191 thereof) is obtained. Specifically, the fluid data 176 may be associated with the fluid 195 flowing through the pipe network 190 (including one or more pipe network sections 191 thereof). In some cases, the fluid data 176 is additionally associated with the ancillary equipment used to physically and/or operationally support the pipe network 190 (including one or more pipe network sections 191 thereof) in the flow of fluid 195 therethrough. The fluid data 176 may be obtained from one or more fluid data sources 175 using communication links 102. The fluid data 176 may be obtained by the controller 204 of the pipe network evaluation system 140 using the application interface 226, the communication module 208, one or more protocols 232, and/or one or more algorithms 233. Some or all of the fluid data 176 may be stored by the controller 204 of the pipe network evaluation system 140 as stored data 234. The fluid data 176 may be obtained at any interval (e.g., instantaneously, continuously, periodically, randomly). The fluid data 176 may cover a period of time (e.g., an hour, a day, a week, a month, a year).

As discussed above, the fluid data 176 for the pipe network 190 (including one or more pipe network sections 191 thereof) may be any data associated with the fluid 195 flowing through the pipe network 190 (including one or more pipe network sections 191 thereof). Examples of fluid data 176 may include, but are not limited to, a composition (e.g., by element, by compound, by percentage, by mass) of the fluid 195, temperature of the fluid 195, a flow rate of the fluid 195, a state (e.g., solid, liquid, gas) of the fluid 195, and a pressure of the fluid 195 within the pipe network 190 (including one or more pipe network sections 191 thereof). Fluid data 176 obtained by the controller 204 may have GPS data and/or other locational information that allows the controller 204 to associate the fluid data 176 with one or more pipe network sections 191 of the pipe network 190.

In step 484, I&M data 178 associated with the pipe network 190 (including one or more pipe network sections 191 thereof) is obtained. Specifically, the I&M data 178 may be associated with the installation, maintenance, calibration, repair, and/or other manipulation of the pipe network 190 (including one or more pipe network sections 191 thereof). In some cases, the I&M data 178 is additionally associated with the installation, maintenance, calibration, repair, and/or other manipulation of the ancillary equipment used to physically and/or operationally support the pipe network 190 (including one or more pipe network sections 191 thereof). The I&M data 178 may be obtained from one or more I&M data sources 177 using communication links 102. The I&M data 178 may be obtained by the controller 204 of the pipe network evaluation system 140 using the application interface 226, the communication module 208, one or more protocols 232, and/or one or more algorithms 233. Some or all of the I&M data 178 may be stored by the controller 204 of the pipe network evaluation system 140 as stored data 234. The I&M data 178 may be obtained at any interval (e.g., instantaneously, continuously, periodically, randomly). The I&M data 178 may cover a period of time (e.g., an hour, a day, a week, a month, a year).

As discussed above, I&M data 178 is any data associated with the installation, maintenance, calibration, repair, and/or other manipulation of the pipe network 190 (including one or more pipe network sections 191 thereof). Accordingly, the I&M data 178 for the pipe network 190 obtained, directly or indirectly, from an I&M data source 177 may be any data associated with changes made to the pipe network 190 (including one or more pipe network sections 191 thereof) during installation, maintenance, calibration, repairs, and/or other events that occur with respect to the pipe network 190 (including one or more pipe network sections 191 thereof). Examples of the I&M data 178 may include, but are not limited to, welding information (e.g., type of weld, location of weld, length/width of weld, welding material used), coatings applied to a surface of the pipe network, and treatment (e.g., heat treatment, ionization) applied to the pipe network 190. I&M data 178 obtained by the controller 204 may have GPS data and/or other locational information that allows the controller 204 to associate the I&M data 178 with one or more pipe network sections 191 of the pipe network 190.

In step 463, monitored response data 154 associated with the pipe network 190 (including one or more pipe network sections 191 thereof) is obtained. Specifically, the monitored response data 154 may be associated with some or all of the physical components (e.g., pipes, supports, elbows, pumps) of the pipe network 190 (including one or more pipe network sections 191 thereof), including ancillary equipment used to physically and/or operationally support the pipe network 190 (including one or more pipe network sections 191 thereof). The monitored response data 154 may be obtained from one or more monitored response data sources 153 using communication links 102. The monitored response data 154 may be obtained by the controller 204 of the pipe network evaluation system 140 using the application interface 226, the communication module 208, one or more protocols 232, and/or one or more algorithms 233. Some or all of the monitored response data 154 may be stored by the controller 204 of the pipe network evaluation system 140 as stored data 234. The monitored response data 154 may be obtained at any interval (e.g., instantaneously, continuously, periodically, randomly). The monitored response data 154 may cover a period of time (e.g., an hour, a day, a week, a month, a year).

Examples of monitored response data 154 may include, but are not limited to, the thickness in the wall of a pipe and/or other component of the pipe network 190, the amount of corrosion in the wall of a pipe and/or other component of the pipe network 190, a crack in a support element of the pipe network 190, a crack in a pipe of the pipe network 190, vibration data, the temperature of a pipe and/or other component of the pipe network 190, and data associated with integrity of the grounding system for some or all of the pipe network 190. Monitored response data 154 obtained by the controller 204 may have GPS data and/or other locational information that allows the controller 204 to associate the monitored response data 154 with one or more pipe network sections 191 of the pipe network 190.

In optional step 419, sensor data 179 associated with the pipe network 190 (including one or more pipe network sections 191 thereof) is obtained. Specifically, the sensor data 179 may be associated with data that may not be included in the design data 152, the monitored response data 154, the manufacturing data 172, the environmental data 174, the fluid data 176, and/or the I&M data 178. In some cases, the sensor data 179 is additionally associated with the ancillary equipment used to physically and/or operationally support the pipe network 190 (including one or more pipe network sections 191 thereof). The sensor data 179 may be obtained from one or more sensor devices 560 using communication links 102. The sensor data 179 may be obtained by the controller 204 of the pipe network evaluation system 140 using the application interface 226, the communication module 208, one or more protocols 232, and/or one or more algorithms 233. Some or all of the sensor data 179 may be stored by the controller 204 of the pipe network evaluation system 140 as stored data 234. The sensor data 179 may be obtained at any interval (e.g., instantaneously, continuously, periodically, randomly). The sensor data 179 may cover a period of time (e.g., an hour, a day, a week, a month, a year).

As discussed above, a sensor device 560 may be independent of the pipe network design sources 151, the monitored response data sources 153 (including the associated sensor devices 660), the manufacturing data sources 171 (including the associated sensor devices 160), the environmental data sources 173 (including the associated sensor devices 260), the fluid data sources 175 (including the associated sensor devices 360), and the I&M data sources 177 (including the associated sensor devices 460) may be used to collect sensor data 179 associated with the pipe network 190 (including one or more pipe network sections 191 thereof). Specifically, a sensor device 560 of the system 199 may be configured to measure one or more parameters associated with the pipe network 190 (including one or more pipe network sections 191 thereof) that are not already measured by the sensor devices 660 of the monitored response data sources 153, by the sensor devices 160 of the manufacturing data sources 171, by the sensor devices 260 of the environmental data sources 173, by the sensor devices 360 of the fluid data sources 175, and by the sensor devices 460 of the I&M data sources 177. Sensor data 179 obtained by the controller 204 may have GPS data and/or other locational information that allows the controller 204 to associate the sensor data 179 with one or more pipe network sections 191 of the pipe network 190.

In step 485, the monitored response data 154, the manufacturing data 172, the environmental data 174, the fluid data 176, the I&M data 178, and the optional sensor data 179 are evaluated. The monitored response data 154, the manufacturing data 172, the environmental data 174, the fluid data 176, the I&M data 178, and the optional sensor data 179 may be evaluated by the data evaluation module 225 of the controller 204 of the pipe network evaluation system 140. The data evaluation module 225 of the controller 204 may evaluate the monitored response data 154, the manufacturing data 172, the environmental data 174, the fluid data 176, the I&M data 178, and the optional sensor data 179 using the communication module 208, one or more protocols 232, one or more algorithms 233, and/or stored data 234.

The data evaluation module 225 of the controller 204 may evaluate the monitored response data 154, the manufacturing data 172, the environmental data 174, the fluid data 176, the I&M data 178, and the optional sensor data 179 continually, periodically (e.g., every minute, every hour, every 24 hours, weekly, monthly), on the occurrence of an event (e.g., obtaining new data (e.g., new environmental data 174, new fluid data 176, new I&M data 178), randomly, and/or on some other basis. Evaluating the monitored response data 154, the manufacturing data 172, the environmental data 174, the fluid data 176, the I&M data 178, and the optional sensor data 179 may include filtering, formatting, grouping, averaging, organizing, validating, and/or otherwise processing some or all of the data.

For example, the data evaluation module 225 of the controller 204 may determine whether the various data has an unrealistic value. As another example, the data evaluation module 225 of the controller 204 may determine whether there are erroneous or frequent zero readings within the data. As yet another example, the data evaluation module 225 of the controller 204 may determine whether data is unrealistic (e.g., unchanging) for an extended period of time. As still another example, the data evaluation module 225 of the controller 204 may determine whether data is spurious.

As yet another example, the data evaluation module 225 of the controller 204 may determine whether there are isolated spikes, isolated dips, or other abnormal readings of the data. As still another example, the data evaluation module 225 of the controller 204 may determine when GPS data is uncorrected. As yet another example, when multiple GPS sources are used, the data evaluation module 225 of the controller 204 may determine when the data from one GPS source is compensated better or worse than the data from another GPS source.

In step 486, the condition of the pipe network 190 (including one or more pipe network sections 191 thereof) is determined. In certain example embodiments, the condition of the pipe network 190 (including one or more pipe network sections 191 thereof) is determined by the condition assessment module 223 of the controller 204 of the pipe network evaluation system 140. The pipe network evaluation system 140 may determine (assess) the condition of the pipe network 190 (including one or more pipe network sections 191 thereof) using the communication module 208, one or more protocols 232, one or more algorithms 233, and/or stored data 234. The pipe network evaluation system 140 may determine (assess) the condition of the pipe network 190 (including one or more pipe network sections 191 thereof) continually, periodically (e.g., every minute, every hour, every 24 hours, weekly, monthly), on the occurrence of an event (e.g., obtaining new data), randomly, and/or on some other basis.

As discussed above, the condition assessment module 223 may assess a current condition of the pipe network 190 (including one or more pipe network sections 191 thereof). In addition, or in the alternative, the condition assessment module 223 may assess a future condition of the pipe network 190 (including one or more pipe network sections 191 thereof) based on trends tracked over time by the condition assessment module 223.

In certain example embodiments, an assessment generated by the condition assessment module 223 may have any of a number of scopes. For example, the condition assessment module 223 may identify particular pipe network sections 191 that are having problems and/or failures, while also identifying the specific problems (e.g., external corrosion, internal erosion, cracking) and/or failures. As another example, additionally or alternatively, the condition assessment module 223 may suggest specific actions that may be taken with respect to particular pipe network sections 191 to prevent a failure from occurring. As yet another example, additionally or alternatively, the condition assessment module 223 may predict or forecast when a failure will occur to one or more particular pipe network sections 191 if no corrective action is taken.

As still another example, additionally or alternatively, the condition assessment module 223 may send instructions to the control engine 206 of the controller 204 so that the control engine 206 may control certain equipment (e.g., a valve, a motor, a heater, a fan) that may isolate an identified failure in the pipe network 190. As yet another example, additionally or alternatively, the condition assessment module 223 may send instructions to the control engine 206 of the controller 204 so that the control engine 206 may control certain equipment (e.g., a valve, a motor, a heater, a fan) that may reduce or eliminate a condition that is causing a deterioration or failure of one or more pipe network sections 191 in the pipe network 190.

In certain example embodiments, the condition assessment module 223 may generate one or more of a number of outputs. Examples of such outputs may include, but are not limited to, a dashboard, a detailed report (e.g., in an email, in text on a display, in an audio file that is broadcast over a speaker, in a text message), an alarm (e.g., a flashing indicating light, a siren), an automated phone recording tailored to the issue, scheduling labor with employees and/or contractors, and purchasing needed parts from vendors. For example, the condition assessment module 223 of the controller 204 of the piing management system 140 may be configured to generate, maintain, update, and/or otherwise manage one or more dashboards, which when used in conjunction with the application interface 226 of the controller 204 provides an interactive interface with a user 150.

In some cases, the condition of the pipe network 190 (including one or more pipe network sections 191 thereof) is in terms of a safety margin for the pipe network 190 (including one or more pipe network sections 191 thereof). In other words, example embodiments may be used to determine if the pipes and/or ancillary components used in the pipe network 190 (including one or more pipe network sections 191 thereof) is over-engineered (e.g., using more expensive pipes that are thicker and/or include a material that are excessive for their use). In such cases, the safety margin analysis may apply to the existing pipe network 190 (including one or more pipe network sections 191 thereof), to another existing pipe network 190 (including one or more pipe network sections 191 thereof) that is similarly situated (e.g., has a substantially similar fluid 195 flowing therethrough, is exposed to substantially similar environmental factors), and/or to a new pipe network 190 (including one or more pipe network sections 191 thereof) that is being planned and designed.

In step 464, a dashboard is presented. The dashboard may be presented using the application interface 226 of the controller 204 of the pipe network evaluation system 140. The dashboard may be configured to provide some or all of the data associated with the pipe network 190 and/or the outputs of one or more of the algorithms 233 (e.g., models) used to evaluate some or all of the pipe network 190. For example, the dashboard may be configured to present a summary of evaluating the manufacturing data 172, the environmental data 174, the fluid data 176, the sensor data 179, and the I&M data 178 against the design data 152. The dashboard may be presented to a user 150, in some cases using a user system 150. In certain example embodiments, the dashboard may be configurable by a user 150. In some cases, the dashboard may have a hierarchy of pages that a user 150 may navigate. In some cases, the dashboard may allow for a user 150 to provide input (e.g., pose a query, correct data, request a report). The dashboard may be generated using one or more protocols 232, one or more algorithms 233, and/or stored data 234.

In step 465, a determination is made as to whether user input is received through the dashboard. Receiving a user input through the dashboard may be a request or command to modify the dashboard in some way (e.g., to change a format, to change data, to execute an algorithm 233, to set different parameters and/or threshold values). Input from a user 150 may be received through the application interface 226 and/or the communication module 208. The user input may be received by the controller 204 of the pipe network evaluation system 140 through the application interface 226 and/or the communication module 208. If user input is received, the process reverts to step 485. If user input is not received, the process proceeds to step 487.

In step 487, a determination is made as to whether there is a difference between an actual condition and a forecast condition with respect to the pipe network 190 (including one or more pipe network sections 191 thereof). The determination as to whether there is a difference between an actual condition and a forecast condition with respect to the pipe network 190 (including one or more pipe network sections 191 thereof) may be made by the control engine 206 using the communication module 208, one or more protocols 232, one or more algorithms 233, and/or stored data 234 (e.g., threshold values).

In order to make this determination, information about the actual condition of the pipe network 190 (including one or more pipe network sections 191 thereof) may be obtained from a user 150 (including an associated user system 155), one or more of the pipe network design sources 151 (e.g., in the form of design data 152), one or more of the monitored response data sources 153 (e.g., in the form of monitored response data 154), one or more of the manufacturing data sources 171 (e.g., in the form of manufacturing data 172), one or more of the environmental data sources 173 (e.g., in the form of environmental data 174), one or more of the fluid data sources 175 (e.g., in the form of fluid data 176), one or more of the I&M data sources 177 (e.g., in the form of I&M data 178), and/or one or more of the optional sensor devices 560 (e.g., in the form of sensor data 179). Information about the actual condition of the pipe network 190 (including one or more pipe network sections 191 thereof) may be based on design, installation, repair, maintenance, replacement, calibration, and/or physical interaction with the pipe network 190 (including one or more pipe network sections 191 thereof). The information about the actual condition of the pipe network 190 (including one or more pipe network sections 191 thereof) may be obtained by the controller 204 of the pipe network evaluation system 140 using one or more communication links 102.

In certain example embodiments, a determination as to whether there is a difference between an actual condition and a forecast condition with respect to the pipe network 190 (including one or more pipe network sections 191 thereof) may be based on a quantifiable difference (e.g., measured values versus estimated values, actual degree of degradation versus estimated degree of degradation). Such a quantifiable difference may be based on a threshold value (e.g., set by default, set based on historical calculations, based on input from a user 150) and/or based on instructions from a user 150 (including an associated user system 155) and/or the network manager 180.

In certain example embodiments, the control engine 206 may be configured to determine whether a difference between an actual condition and a forecast condition with respect to the pipe network 190 (including one or more pipe network sections 191 thereof) may be based on faulty data (e.g., a failed or failing sensor device 360, a typographical error) obtained by the controller 204 and used to determine the condition of the pipe network 190 as opposed to an algorithm 233 that needs to be adjusted. If there is a difference between an actual condition and a forecast condition with respect to the pipe network 190 (including one or more pipe network sections 191 thereof), then the process proceeds to step 488. If there is not a difference between an actual condition and a forecast condition with respect to the pipe network 190 (including one or more pipe network sections 191 thereof), then the process proceeds to step 489.

In step 488, one or more of the algorithms 233 is adjusted. An algorithm 233 (e.g., a model) may be adjusted by the control engine 206 of the controller 204. In certain example embodiments, an algorithm 233 may be adjusted using a self-learning process, as discussed above. Each algorithm 233 may be adjusted (also sometimes referred to as tuned or trained) using one or more protocols 232 and/or one or more other algorithms 233. Adjusting an algorithm 233 may include tuning portions thereof, including but not limited to inputs, parameters, protocols 232, algorithms 233, tables, and decision trees. An algorithm 233 may be adjusted in any of a number of different ways. For example, an algorithm 233 may be adjusted using a blind test, selected from some period of time (e.g., 12 months throughout a calendar year). The remaining raw dataset may be split (e.g., 80% and 20%) between training and 20% testing during the model training. The difference between the blind test dataset and 20% testing dataset is that the former was not seen by the model or other type of algorithm 233 during training/tuning/adjusting.

When logic or decisions trees are used, the decision trees may be trained in succession so that each new (or modified) model or other type of algorithm 233 may correct errors found in the previous version. Also, the parameters defining one or more decision trees may be adjusted. For instance, various parameters of a model or other type of algorithm 233 may be selected and iteratively tuned by performing a grid search using an n-fold cross-validation method on the training dataset.

As another example, the number of logic trees may be changed. As still another example, the learning rate (sometimes called eta or the rate of shrinkage) after each iteration may be changed. As yet another example, the number of samples required in order to add a node to a decision tree may be changed. As still another example, the maximum number of nodes from the root to a leaf in a decision tree (also referred to as the maximum depth of a decision tree) may be changed. As still another example, the subsampling ratio of the data samples used to train a model (or other type of algorithm 233) or a logic tree may be changed. As yet another example, the subsampling ratio of columns of the data samples used to build a new logic tree may be changed. As still another example, the minimum loss reduction required to make a split on a leaf node of a logic tree may be changed.

In some cases, one or more algorithms that are adjusted are part of one or more of the pipe network design sources 151. In such cases, an algorithm of a pipe network design source 151 may be directly adjusted by the controller 204. Alternatively, the controller 204 may provide feedback data that allows one or more of the pipe network design sources 151 to assess and adjust one or more of its algorithms. In this way, the design data 152 associated with the design of future pipe networks 190 and generated by the one or more pipe network design sources 151 may be more accurate with the benefit of the adjusted algorithms. When step 488 is complete, the process reverts to step 485.

In step 489, a course of action with respect to the pipe network 190 (including one or more pipe network sections 191 thereof) is recommended. In certain example embodiments, the one or more recommendations as to a course of action with respect to the pipe network 190 (including one or more pipe network sections 191 thereof) may be made by the condition assessment module 223 of the controller 204 of the pipe network evaluation system 140. As an example, the condition assessment module 223 of the controller 204 of the pipe network evaluation system 140 may recommend that, after determining that the initial flaw size per design exceeds the as-built flaw size, and that the amount of time for a fracture to occur at a flaw height under the initial design is less than the amount of time for a fracture to occur at substantially the same flaw height under the as-built design, the margin may safely and reliably be used for additional acid flowbacks through the pipe network 190. A recommendation made by the condition assessment module 223 may be based on using the communication module 208, one or more protocols 232, one or more algorithms 233, and/or stored data 234. When step 489 is complete, the process proceeds to the END step.

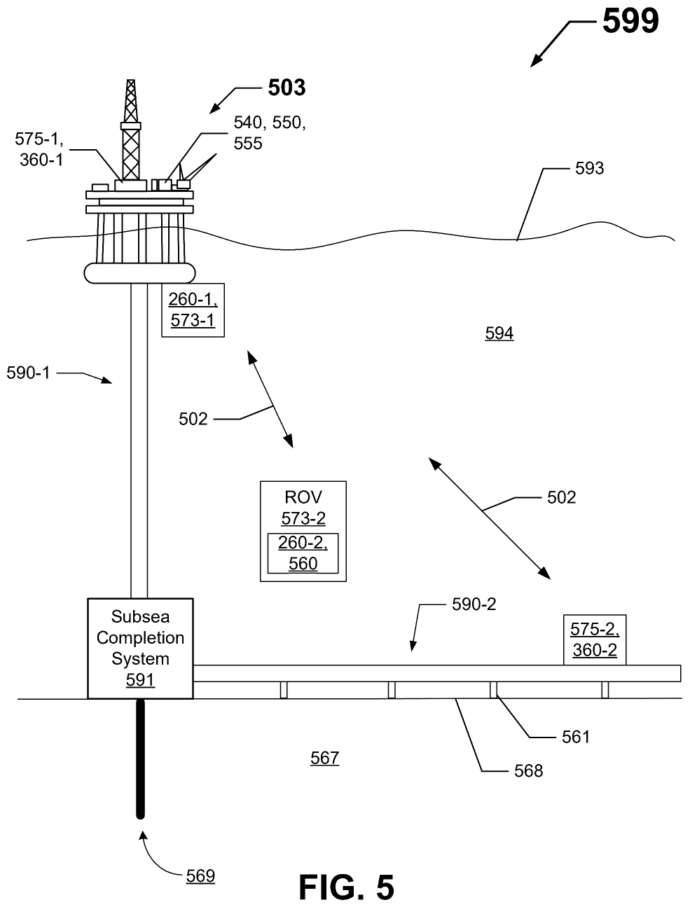

FIG. 5 shows a system 599 that includes two pipe networks 590 that are evaluated according to certain example embodiments. Referring to the description above with respect to FIGS. 1 through 4, the system 599 of FIG. 5 includes a subsea completion system 591 (e.g., a manifold, a wellhead, a BOP, a Xmas tree) located in the water 594 at or near the seabed 568, a wellbore 569 in a subterranean formation 567, a floating structure 503 that floats in the water 594 at a waterline 593, an example pipe network evaluation system 540 located on the floating structure 503, a user 550 and associated user system 555 located on the floating structure 503 at the top of a pipe network 590-1 in the form of a riser that extends from the floating structure 503 to the subsea completion system 591, an environmental data source 573-1 with one or more associated sensor devices 260-1 located in the water 594 on the floating structure 503, another pipeline network 590-2 in the form of a pipeline that is positioned on or near the seabed 568 and extends outward from the subsea completion system 591, a fluid data source 575-2 with one or more associated sensor devices 360-2 that is attached to the pipe network 590-2, and an environmental data source 573-2 in the form of a ROV that includes one or more associated sensor devices 260-2 and one or more independent sensor devices 560. In some cases, the supports 561 that stabilize the pipeline network 590-2 near the seabed 568 may be considered part of the pipeline network 590-2 that is evaluated by the pipe network evaluation system 540.

The various data sources (specifically, the environmental data source 573-1, the environmental data source 573-2, the fluid data source 575-1, the fluid data source 575-2, and the sensor device 560), the user 550 (including the associated user system 555), and the pipeline evaluation system 540 communicate with each other using communication links 502. The environmental data sources 573 (including the associated sensor devices 260), the fluid data sources 575 (including the associated sensor devices 360), the sensor devices 560, the user 550 (including the associated user system 555), the pipeline evaluation system 540, the pipeline networks 590, and the communication links 502 are substantially the same as the corresponding components discussed above with respect to FIGS. 1 through 4.

The pipeline evaluation system 540 obtains environmental data (substantially the same as the environmental data 172 discussed above) from the environmental data source 573-1 (including from the one or more sensor devices 260-1) and the environmental data source 573-2 (including from the one or more sensor devices 260-2), fluid data (substantially the same as the fluid data 174 discussed above) from the fluid data source 575-1 (including from the one or more sensor devices 360-1), and sensor data (substantially similar to the sensor data 179 discussed above) from the one or more sensor devices 560, as well as previously obtained manufacturing data (substantially similar to the manufacturing data 172 discussed above) from one or more manufacturing data sources (substantially similar to the manufacturing data sources 171 discussed above), previously obtained design data (substantially similar to the design data 152 discussed above) from one or more pipe network design sources (substantially similar to the one or more pipe network design sources 151 discussed above), and previously obtained I&M data (substantially similar to the I&M data 178 discussed above) from one or more I&M data sources (substantially similar to the I&M data sources 177 discussed above), to evaluate the pipeline network 590-1 in the form of a riser.

Similarly, the pipeline evaluation system 540 obtains environmental data (substantially the same as the environmental data 172 discussed above) from the environmental data source 573-2 (including from the one or more sensor devices 260-2), fluid data (substantially the same as the fluid data 174 discussed above) from the fluid data source 575-2 (including from the one or more sensor devices 360-2), and sensor data (substantially similar to the sensor data 179 discussed above) from the one or more sensor devices 560, as well as previously obtained manufacturing data (substantially similar to the manufacturing data 172 discussed above) from one or more manufacturing data sources (substantially similar to the manufacturing data sources 171 discussed above), previously obtained design data (substantially similar to the design data 152 discussed above) from one or more pipe network design sources (substantially similar to the one or more pipe network design sources 151 discussed above), and previously obtained I&M data (substantially similar to the I&M data 178 discussed above) from one or more I&M data sources (substantially similar to the I&M data sources 177 discussed above), to evaluate the pipeline network 590-2 in the form of the subsea pipeline and supports 561.

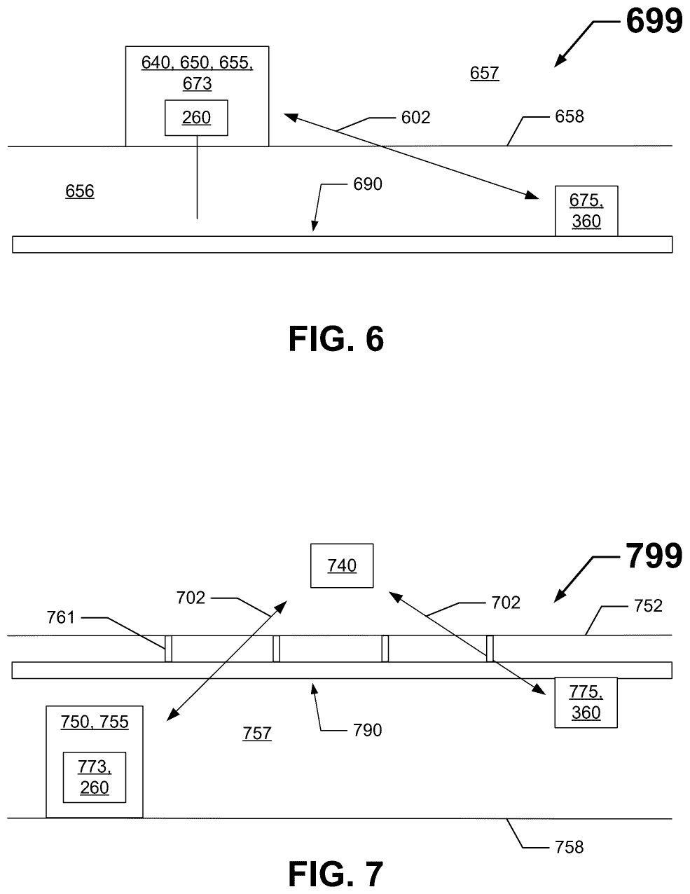

FIG. 6 shows another system 699 that includes a pipe network 690 that is evaluated according to certain example embodiments. Referring to the description above with respect to FIGS. 1 through 5, the system 699 of FIG. 6 includes an example pipe network evaluation system 640, combined with a user 650, an associated user system 655, and an environmental data source 675 (including one or more associated environmental sensor devices 260), located above ground level 658 in an ambient environment 657, a pipe network 690 in the form of a pipeline buried in the ground 656, and an environmental data source 673 with one or more associated sensor devices 260 located in the ambient environment 657 above the ground 656, where the sensor devices 260 includes a probe that extends into the ground 656 adjacent to the pipeline network 690.

The various data sources (specifically, the environmental data source 673 and the fluid data source 675), the user 650 (including the associated user system 655), and the pipeline evaluation system 640 communicate with each other using communication links 602. The environmental data source 673 (including the associated sensor devices 260), the fluid data source 675 (including the associated sensor devices 360), the user 650 (including the associated user system 655), the pipeline evaluation system 640, the pipeline network 690, and the communication links 602 are substantially the same as the corresponding components discussed above with respect to FIGS. 1 through 4.

The pipeline evaluation system 640 obtains environmental data (substantially the same as the environmental data 172 discussed above) from the environmental data source 673 (including from the one or more sensor devices 260) and fluid data (substantially the same as the fluid data 174 discussed above) from the fluid data source 675 (including from the one or more sensor devices 360), as well as previously obtained manufacturing data (substantially similar to the manufacturing data 172 discussed above) from one or more manufacturing data sources (substantially similar to the manufacturing data sources 171 discussed above), previously obtained design data (substantially similar to the design data 152 discussed above) from one or more pipe network design sources (substantially similar to the one or more pipe network design sources 151 discussed above), and previously obtained I&M data (substantially similar to the I&M data 178 discussed above) from one or more I&M data sources (substantially similar to the I&M data sources 177 discussed above), to evaluate the pipeline network 690 in the form of a buried pipeline (e.g., where the fluid (e.g., fluid 195) that flows through the pipeline network 690 is oil, where the fluid is natural gas, where the fluid is propane). In alternative embodiments, the pipeline network 690 may be in the form of a buried waterline where the fluid that flows through the pipeline network 690 is water.

FIG. 7 shows yet another system 799 that includes a pipe network 790 that is evaluated according to certain example embodiments. Referring to the description above with respect to FIGS. 1 through 6, the system 799 of FIG. 7 includes an example pipe network evaluation system 740 located above a ceiling 752 that isolates the pipe network evaluation system 740 from an ambient environment 757, a user 750 with an associated user system 755 and an environmental data source 775 (including one or more associated environmental sensor devices 260) located above ground level 758 and below the ceiling 752 in the ambient environment 757, a pipe network 790 in the form of a chemical process line located above ground level 758 and below the ceiling 752 in the ambient environment 757, and a fluid data source 775 with one or more associated sensor devices 360 located above ground level 758 and below the ceiling 752 in the ambient environment 757 adjacent to the pipeline network 790. In some cases, the supports 761 that suspend the pipeline network 790 from the ceiling 752 may be considered part of the pipeline network 790 that is evaluated by the pipe network evaluation system 740.

The various data sources (specifically, the environmental data source 773 and the fluid data source 775), the user 750 (including the associated user system 755), and the pipeline evaluation system 740 communicate with each other using communication links 702. The environmental data source 773 (including the associated sensor devices 260), the fluid data source 775 (including the associated sensor devices 360), the user 750 (including the associated user system 755), the pipeline evaluation system 740, the pipeline network 790, and the communication links 702 are substantially the same as the corresponding components discussed above with respect to FIGS. 1 through 4. The ambient environment 757 in this case may be caustic.

The pipeline evaluation system 740 obtains environmental data (substantially the same as the environmental data 172 discussed above) from the environmental data source 773 (including from the one or more sensor devices 260) and fluid data (substantially the same as the fluid data 174 discussed above) from the fluid data source 775 (including from the one or more sensor devices 360), as well as previously obtained manufacturing data (substantially similar to the manufacturing data 172 discussed above) from one or more manufacturing data sources (substantially similar to the manufacturing data sources 171 discussed above), previously obtained design data (substantially similar to the design data 152 discussed above) from one or more pipe network design sources (substantially similar to the one or more pipe network design sources 151 discussed above), and previously obtained I&M data (substantially similar to the I&M data 178 discussed above) from one or more I&M data sources (substantially similar to the I&M data sources 177 discussed above), to evaluate the pipeline network 790 (which may include the supports 761) where the fluid (e.g., fluid 195) that flows through the pipeline network 790 is a chemical used in a chemical plant and where the ambient environment 757 may be caustic.

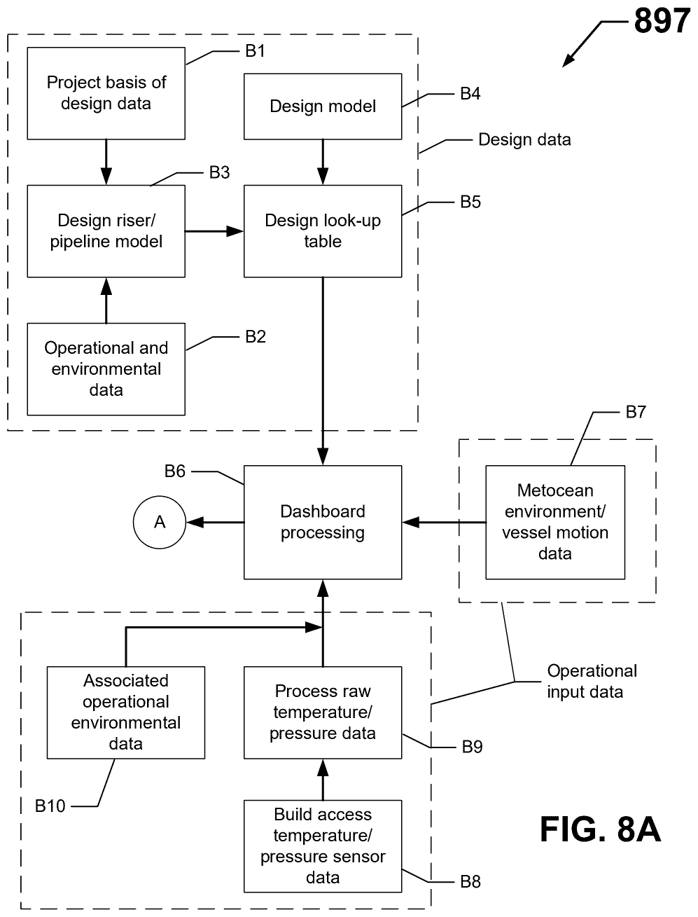

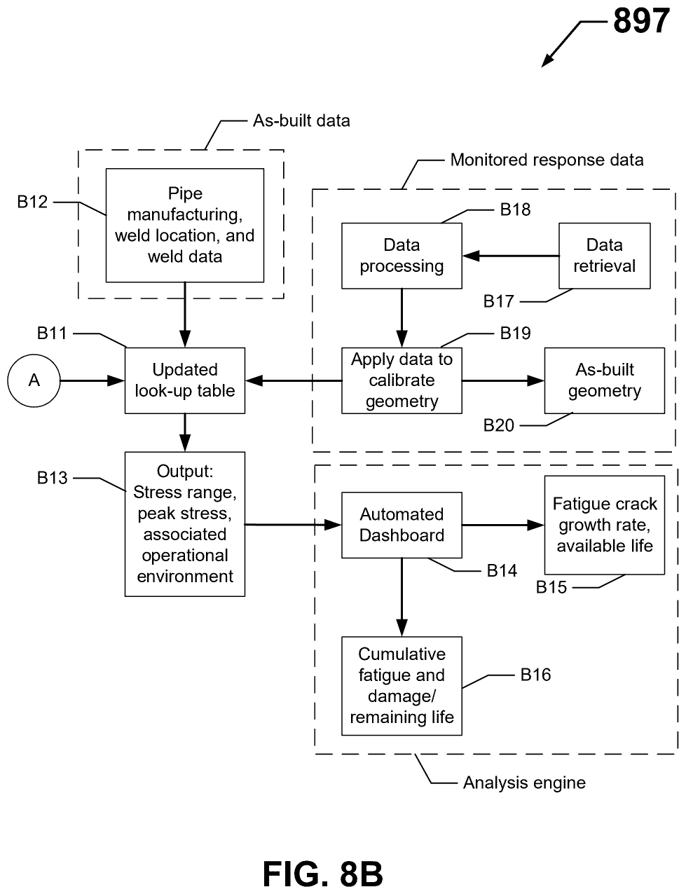

FIGS. 8A and 8B show a functional diagram 897 for evaluating a subsea pipeline according to certain example embodiments. Referring to the description above with respect to FIGS. 1 through 7, the functional diagram 897 of FIGS. 8A and 8B starts with a design data section, which corresponds to the design data 152 generated by the one or more pipe network design sources 151 of FIG. 1. The initial inputs are block B1 (“project basics of design data”) and block B2 (“operational and environmental data”). Block B1 corresponds to specifications, requirements, and other objectives of a proposed pipe network 190. The information included in Block B1 may be provided, for example, by a user 150 (including an associated user system 155) (e.g., a project manager, a regulatory agency) and/or a manufacturing data source 171.

Block B3 corresponds to data associated with operations for which the proposed pipe network 190 would be used and the environment in which the proposed pipe network 190 would be exposed. The information included in Block B3 may be provided, for example, by a user 150 (including an associated user system 155) (e.g., a project manager, a regulatory agency), an environmental data source 173, and/or a fluid data source 175. The information generated in Block B3 may be developed using a finite element analysis model (a form of an algorithm 233).

The information from Block B1 and Block B3 are fed to Block B2 (“Design riser/pipeline model”), which represents one or more algorithms that are configured to design a riser and subsea pipeline as part of a pipe network 190. The output of Block B3 is used, along with the output of Block B4, to feed Block B5. Block B4 (“Design model”) represents one or more algorithms that are configured to design other aspects (e.g., support structures, manifolds) of the pipe network 190.

Block B5 (“Design look-up table”) uses the information provided by the models of Block B3 and Block B4 to generate and maintain one or more look-up tables that correlate two or more variables (e.g., an inner diameter of a pipe of the pipe network 190, an outer diameter of a pipe of the pipe network 190) over various conditions (e.g., temperature, pressure). A look-up table of Block B5 may be used to provide insight as to how the pipe network 190 (or portions thereof) should behave under certain conditions (e.g., environmental conditions, interaction with a fluid flowing therethrough).

In this case, a look-up table generated in Block B5 is used as an input for Block B6 (“Dashboard processing”). In addition, Block B7 and Block B10 are used as inputs for Block B6. Block B7 (“Metocean environment/vessel motion data”) is part of operational input data. Block B7 corresponds to environmental data 174 associated with the environment 194 in which the pipe network 190 is located. With the pipe network 190 directed to a subsea pipeline that includes a riser, the information from Block B7 is used by the dashboard processor of Block B6. The environmental data 174 output from Block B6 may be provided by one or more environmental data sources 173, including one or more associated sensor devices 260.

The other operational input data that feeds the dashboard processor (part of the pipe network evaluation system 140, such as the control engine 206 or the condition assessment module 223 of the controller 204) of Block B6 are derived from Block B8, Block B9, and Block B10. Block B8 (“Build access temperature/pressure sensor data”) may include monitored response data 154 from one or more monitored response data sources 153 and/or environmental data 174 from one or more environmental data sources 173. The information collected as part of Block B8 is then provided to Block B9 (“Process raw temperature/pressure data”) so that the monitored response data 154 and/or the environmental data 174 may be processed (e.g., filtered, formatted, organized, grouped, averaged). Block B9 may be performed by the pipe network evaluation system 140, one or more of the monitored response data sources 153, and/or environmental data 174 from one or more of the environmental data sources 173.

The processed monitored response data 154 and/or environmental data 174 is provided by Block B9 to the dashboard processor of the pipe network evaluation system 140 of Block B6. In addition, Block B10 (“Associated operational environmental data”) provides monitored response data 152, fluid data 176, and/or environmental data 174 to the dashboard processor of the pipe network evaluation system 140 of Block B6. The monitored response data 154, fluid data 176, and/or environmental data 174 provided by Block B10 may be generated by one or more monitored response data sources 153, one or more monitored response data sources 153, and/or one or more environmental data sources 173. In this particular example, the associated operational environmental data may be information associated with different types of fluids (e.g., sour, non-sour, acidic) that interact with (e.g., flow through) the pipe network 190.

In Block B11, the dashboard processor of Block B6 updates (e.g., continuously, periodically) one or more look-up tables that were previously produced in Block B5 for use in the dashboard of Block B14, discussed below. The updated look-up tables in Block B11 may also be updated using Block B12 (“Pipe manufacturing, weld location, and weld data”). The information in Block B12 may be or include manufacturing data 172 (e.g., provided by one or more manufacturing data sources 171) and/or I&M data 178 (e.g., provided by one or more I&M data sources 177).

The dashboard processor of Block B11 also uses output from a series of blocks that make up a monitored response data grouping. In this case, Block B17, Block B18, Block 19, and Block 20 are included in the monitored response data grouping of FIG. 8B. Block 17 (“Data retrieval”) may be configured to retrieve or otherwise obtain any information associated with monitored response data 154. Such information may be obtained from one or more monitored response data sources 153, including one or more sensor devices 660. In some cases, other types of data (e.g., sensor data 179, I&M data 178, fluid data 176) from one or more other sources (e.g., one or more sensor devices 560, one or more I&M data sources 177 (including one or more sensor devices 460), one or more fluid data sources 175 (including one or more sensor devices 360)) may be obtained in Block 17.

In Block 18 (“Data processing”), the data obtained in Block 17 is processed (e.g., filtered, formatted, averaged, grouped, ordered, categorized) by the controller 204 of the pipe network evaluation system 140 and/or by a controller (e.g., similar to the controller 204) of one or more of the monitored response data sources 153. In Block 19 (“Apply data to calibrate geometry”), the processed monitored response data 154 is applied to calibrate (e.g., validate, test, update) one or more models (e.g., algorithm 233). In some cases, the output of Block B19 may be fed back as an input to Block 19 to further calibrate the geometry. In Block 20 (“As-built geometry”), the output of Block 19 is used to develop an as-built geometry for some or all of the pipe network 190 (including one or more pipe network sections 191 thereof).

The information generated in Block B19 may be developed using a finite element analysis model (a form of an algorithm 233). In some cases, the output of Block B19 may be used as an input to Block B11. When the look-up tables are updated in Block 11, the information in these look-up tables may be incorporated into Block B13, which provides the information to an analysis engine (e.g., the condition assessment module 223 of the controller 204 of the pipe network evaluation system 140). In this example, the information in Block B13 includes stress range, peak stress, and associated operational information.

The analysis engine that obtains the information in Block 13 includes Block B14, Block 15, and Block 16. In this case, Block B14 (“Automated dashboard”) receives the information from Block 13. The automated dashboard of Block B14 may function as a display of information and/or an interactive interface with respect to a user 150. The dashboard may be automated in one or more of a number of ways. For example, the dashboard may automatically update itself as new data (e.g., monitored response data 154, I&M data 178, fluid data 176) is obtained by the dashboard processor of Block B6 to the extent that the new data effect the current outputs of the models (e.g., forms of algorithms 233). As another example, the dashboard may automatically interact with a user 150.

The information generated in Block B14 may be developed using an engineering criticality assessment model (a form of an algorithm 233). The output or display of the dashboard of Block B14 may include any relevant information associated with the pipe network 190. For example, in this case, the output of Block B14 includes Block B15 (“Fatigue crack growth rate, available life”) and Block B16 (“Cumulative fatigue and damage/remaining life”). This information output by the dashboard may be used by the analysis engine (e.g., the condition assessment module 223 of the controller 204 of the pipe network evaluation system 140) to assess the condition of the pipe network 190 (including one or more pipe network sections 191 thereof).

For example, Block B15 may provide information about specific cracks (e.g., crack geometry, stress fracture characteristics) in one or more pipes and/or other components of the pipe network 190. Block B15 may also present stresses and crack geometries relative to material fracture toughness and/or other characteristics of the pipe network 190 (or portions thereof). As another example, Block B16 may provide information about stress relative to material strength to reveal fatigue, damage, and/or remaining life of the pipe network 190 (including portions thereof).

Example embodiments may be used to evaluate, in real time, a pipe network. Example embodiments may be used for some or all of a field operation. Example embodiments may be used to make or suggest real time adjustments to a pipe network (or one or more pipe network sections thereof) so that the pipe network may have an extended useful life in spite of the harsh environment in which the pipe network operates and/or the stresses and strains that the pipe network experiences over time. Example embodiments may provide a number of benefits. Such other benefits may include, but are not limited to, reduced use of resources, cost savings, increased flexibility, and compliance with applicable industry standards and regulations.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for evaluating a pipe network in service, the method comprising:
obtaining design data for the pipe network, wherein the design data comprises details about a design of the pipe network;
obtaining manufacturing data for the pipe network, wherein the manufacturing data comprises a thickness of pipe network sections of the pipe network and a material of the pipe network sections of the pipe network;
obtaining environmental data associated with the pipe network while the pipe network is in service, wherein the environmental data comprises a range of temperatures at which the pipe network is exposed, a range of humidity at which the pipe network is exposed, and a medium in which the pipe network is placed;
obtaining fluid data for fluid flowing through the pipe network while the pipe network is in service, wherein the fluid data comprises a composition of the fluid;
obtaining installation and maintenance (I&M) data associated with installing and maintaining the pipe network;
evaluating the manufacturing data, the environmental data, the fluid data, and the I&M data against the design data using a plurality of algorithms; and
determining, based on evaluating the manufacturing data, the environmental data, the fluid data, and the I&M data against the design data, a condition of the pipe network while the pipe network is in service.

2. The method of claim 1, wherein the manufacturing data further comprises information associated with redefining a useful life based on a welding flaw applied to the pipe network sections of the pipe network.

3. The method of claim 1, wherein the fluid data further comprises a pH value and a flow rate of the fluid.

4. The method of claim 1, wherein the material of the pipe network comprises a lining along an inner surface of the pipe network sections of the pipe network.

5. The method of claim 1, further comprising:
determining that the condition of the pipe network falls outside of acceptable operating parameters; and
recommending a course of action with respect to the pipe network.

6. The method of claim 5, further comprising:
identifying a particular pipe network section of the pipe network to which the course of action is directed.

7. The method of claim 1, wherein the pipe network is used in oil or gas operations, wherein the pipe network comprises at least one of a group consisting of a riser, a pipeline, a tubing string, and a casing string.

8. The method of claim 7, wherein the pipe network is disposed subsea.

9. The method of claim 8, wherein the environmental data comprises metocean data.

10. The method of claim 7, further comprising:
recommending a new pipe network for a new well based on the condition of the pipe network.

11. The method of claim 1, further comprising:
obtaining sensor data from a sensor device while the pipe network is in service, wherein the sensor data is independent of the manufacturing data, the environmental data, the fluid data, and the I&M data, and wherein determining the condition of the pipe network while the pipe network is in service is further based on evaluating the sensor data.

12. The method of claim 1, wherein the pipe network is used for at least one of a group consisting of water delivery and a process for a chemical plant.

13. The method of claim 1, further comprising:
presenting a dashboard, wherein the dashboard comprises a summary of evaluating the manufacturing data, the environmental data, the fluid data, and the I&M data against the design data; and
receiving an input through the dashboard to modify the dashboard.

14. The method of claim 1, wherein the plurality of algorithms is developed specifically for the pipe network.

15. The method of claim 1, wherein the plurality of algorithms is trained and tested using the manufacturing data, the environmental data, the fluid data, and the I&M data over time.

16. The method of claim 1, wherein the condition of the pipe network is in terms of a safety margin for the pipe network.

17. The method of claim 1, further comprising:
comparing an actual condition of the pipe network that is replaced with a predicted condition of the pipe network, wherein the predicted condition is based on output of the plurality of parameters; and
adjusting at least one of the plurality of algorithms to account for a difference between the actual condition and the predicted condition of the pipe network.

18. A system for evaluating a pipe network in service, the system comprising:
a controller configured to:
obtain design data for the pipe network, wherein the design data comprises details about a design of the pipe network;
obtain manufacturing data for the pipe network, wherein the manufacturing data comprises a thickness of pipe network sections of the pipe network and a material of pipe network sections of the pipe network;
obtain environmental data associated with the pipe network while the pipe network is in service, wherein the environmental data comprises a range of temperatures at which the pipe network is exposed, a range of humidity at which the pipe network is exposed, and a medium in which the pipe network is placed;
obtain fluid data for fluid flowing through the pipe network while the pipe network is in service, wherein the fluid data comprises a composition of the fluid;
obtain installation and maintenance (I&M) data associated with installing and maintaining the pipe network;
evaluate the manufacturing data, the environmental data, the fluid data, and the I&M data against the design data using a plurality of algorithms; and
determine, based on evaluating the manufacturing data, the environmental data, the fluid data, and the I&M data against the design data, a condition of the pipe network while the pipe network is in service.

19. The system of claim 18, further comprising:
a plurality of sensor devices configured to takes a plurality of measurements of a plurality of parameters associated with the pipe network, wherein the plurality of sensor devices is communicably coupled to the controller, wherein the controller determines the condition of the pipe network further based on the plurality of measurements.

20. A non-transitory computer readable medium comprising computer readable program code, which when executed by a computer processor, enables the computer processor to:
obtain design data for a pipe network, wherein the design data comprises details about a design of the pipe network;
obtain manufacturing data for the pipe network, wherein the manufacturing data comprises a thickness of pipe network sections of the pipe network and a material of pipe network sections of the pipe network;
obtain environmental data associated with the pipe network while the pipe network is in service, wherein the environmental data comprises a range of temperatures at which the pipe network is exposed, a range of humidity at which the pipe network is exposed, and a medium in which the pipe network is placed;
obtain fluid data for fluid flowing through the pipe network while the pipe network is in service, wherein the fluid data comprises a composition of the fluid;
obtain installation and maintenance (I&M) data associated with installing and maintaining the pipe network;
evaluate the manufacturing data, the environmental data, the fluid data, and the I&M data against the design data using a plurality of algorithms; and
determine, based on evaluating the manufacturing data, the environmental data, the fluid data, and the I&M data against the design data, a condition of the pipe network while the pipe network is in service.
